(19) United States
(12) Patent Application Publication
(10) Pub. No.: US 2009/0004398 A1
(43) Pub. Date: Jan. 1, 2009

(54) Method for producing multi layered coating film

(76) Inventors: Tetsuji Nitta, Aichi (JP); Yoshiki Kawabe, Osaka (JP); Tatsuya Tongu, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 12/213,873

(22) Filed: Jun. 25, 2008

(30) Foreign Application Priority Data
Jun. 29, 2007 (JP) 2007-171749
Jun. 29, 2007 (JP) 2007-171752

(51) Int. Cl. B05D 7/00

(52) U.S. Cl. 427/407.1; 524/502

(57) ABSTRACT

A method for producing a multi layered coating film by applying an intermediate coating composition on an article to form an intermediate coating thereon; applying a metallic color base coating composition on the intermediate coating to form a metallic color base coating thereon; and applying a clear coating composition on the metallic color base coating to form a clear coating thereon. The metallic color base coating composition is waterborne and contains an acryl emulsion resin; a water dispersion of a hydrophobic melamine resin having an average particle size within a range of from 20 to 300 nm; a luster color pigment; and an organic alcohol solvent having a solubility in water within a range of from 0.01 to 5.0 wt % and a boiling point within a range of from 160 to 200° C.

### TECHNICAL FIELD

The present invention relates to a method for producing a multi layered coating film and a waterborne metallic color base coating composition applicable to the method.

### BACKGROUND OF THE INVENTION

For example, an appearance of an automobile can be established by a coating method including electrodeposition coating with a high corrosion resistance to an article such as a steel plate; applying an intermediate coating composition thereon; applying a coloring base coating composition thereon, and applying a clear coating composition thereon in order to provide a superior design and a good appearance. A metallic color base coating composition comprising a luster color pigment, such as a metallic color pigment, is often employed for the coloring base coating composition in order to provide a metallic brilliant appearance. In the art of coatings for automobiles, solvent type coating compositions have been altered to waterborne coating compositions, in an aspect of environment, and recently, solvent type metallic color base coating compositions have been altered to waterborne metallic color base coating compositions as well.

In order to further reduce burden to the environment, there is a method for coating including applying a waterborne metallic color base coating composition; applying a clear coating composition thereon, without heating and curing the previous applied coating composition; and simultaneously heating and curing these applied coating compositions, which is sometimes referred to as a two-coating and one-baking coating method in the art. The waterborne metallic color base coating composition applicable to such a two-coating and one-baking coating method includes, for example, those containing an acryl emulsion resin, a melamine resin and a luster color pigment (i.e., a luster color material) (see Japanese Unexamined Patent Publication No. 63-193968 corresponding to U.S. Pat. No. 4,900,774 (hereinafter referred to as Patent Document 1) and Japanese Unexamined Patent Publication No. 2002-308993 (hereinafter referred to as Patent Document 2)).

A metallic color base coating film obtained or obtainable by such a coating method is superior in its appearance, and therefore can be applied to many articles such as automobiles. However, preferences of consumers require more superior appearance, and therefore, in the art of highly expensive cars, there is necessity for providing a metallic color base coating film with a much superior appearance. However, with respect to the conventional metallic color base coating film, for example, in a case that a luster color pigment such as an aluminum pigment is contained therein, there is a problem such as aggregate due to agglomeration of the luster color pigment.

The aggregate due to agglomeration of luster color pigment is a phenomenon on a coating film, wherein distribution or orientation of a luster color pigment such as a metallic color pigment is partially disturbed, and white spots are apparently observed. Although the phenomenon of the aggregate due to agglomeration of the luster color pigment is occasionally observed on a coating film resulting from a conventional solvent type coating composition comprising a metallic luster color pigment, this phenomenon is too slight to be appreciated. Therefore, this phenomenon is generally ignored. However, particularly in the field of the above-described highly expensive cars, when the coating film resulting from the waterborne metallic color base coating composition has the slight aggregate due to agglomeration of the luster color pigment, it should be recognized as a coating failure. Therefore, improvements are required.

In addition, with respect to the waterborne metallic color coating composition, as shown in FIG. 1, in order to prevent sedimentation of solid contents such as pigments therein, a coating composition 1 is stirred in a circulation tank 2 with a stirring means 3, and the coating composition is forced to be returned to the circulation tank 2, through a coating means 6, with a circulation pump 4. In this case, it is known that a phenomenon called as skinning of the coating composition occurs, since the circulation tank 2 is generally opened, i.e., not closed. Therefore, fragment of membrane formed by skinning is contaminated in the coating composition and provides failures on a coating film resulting from the contaminated coating composition. The skinning occurs at a surface area wherein the coating composition in the circulation tank 2 is brought in contact with air in the same manner as in the case wherein warmed milk forms a thin film on its surface due to a decrease in its temperature. If the surrounding coating composition is stirred, the skinning occasionally disappears. Herein, skinning is referred to as a state in which the resulting thin film remains on or in the coating composition. The resulting coating film associated with the skinning can be usually removed off with a physical means such as a filtration device. However, a filtration device 8 or 9 may be clogged. Alternatively, complete removal is occasionally difficult. Therefore, these procedures are complicated and take much cost.

Herein, a phenomenon referred to as an aggregate due to agglomeration sometimes occurs while the coating composition circulates between the circulation tank 2 and the coating means 6. This phenomenon occurs in the same manner as in the skinning. While the coating composition circulates in the circulation system, particularly in the circulation tank 2, the coating composition is brought in contact with surrounding external air or brought in contact with air bubbles in the coating composition due to elevation or depression of surface (line) of the coating composition depending on applying or refilling of the coating composition. Therefore, components contained in the coating composition are agglomerated to give solid agglomerates, i.e., aggregate due to agglomeration. As stated above, the aggregate due to agglomeration can be removed off by a physical means such as a filtration device. However, a filtration device 8 or 9 may be clogged. Alternatively, complete removal is occasionally difficult. Therefore, these procedures are complicated and take much cost.

In this field, known conventional methods includes a method for prevention of skinning in a container in order to store, in the container, a waterborne coating composition comprising foam resin particles to form a lightweight thick film (see Japanese Unexamined Patent Publication No. 11-228874 (hereinafter referred to as Patent Document 3)) and a waterborne coating composition which can solve problems such as generation of a large amount of bubbles, skinning, popping and buildup, and which has good washable properties, in particular, a coating composition suitable for coating of cans (see Japanese Unexamined Patent Publication No. 11-349894 (hereinafter referred to as Patent Document 4)). However, they are not related to any waterborne metallic color coating compositions. Therefore, in this field, there are desired a development of a method for conveniently and economically resolving the skinning of a waterborne metallic color coating composition and aggregate due to agglomeration as well as a development of a waterborne metallic color coating composition.

### SUMMARY OF THE INVENTION

### Disclosure of the Invention

### Problem to be Solved by the Invention

Object of the present invention consists in provision of a method for producing a multi layered coating film which can prevent aggregate due to agglomeration of luster color pigment as well as provision of a waterborne metallic color base coating composition applicable to the method (hereinafter referred to as first object).

Another object of the present invention consists in provision of a method for producing a multi layered coating film which can suppress and/or prevent skinning and aggregate due to agglomeration as well as provision of a waterborne metallic color base coating composition applicable to the method (hereinafter referred to as second object).

### Means for Solving the Problem

The present inventors have intensively investigated in order to achieve the first object. As a result, with respect to the phenomenon of aggregate due to agglomeration of luster color pigment, the present inventors have found that the phenomenon arises from generation of coating grains (i.e., dusts) containing a luster color pigment in a high concentration upon applying waterborne metallic color base coating composition, and arises from unusual their long-term flight to a surface of an article to be coated. The dusts reach to an article to be coated in an unusual long time. Therefore, during the time period, solvent predominantly besides water in the coating composition is easily evaporated and the components in the coating composition is highly concentrated. In the case that the highly concentrated dusts are applied to a surface of an article to be coated, and miscible or diluted with the surrounding applied coating composition, there are no problems. In the case that the highly concentrated dusts are not miscible or diluted with the surrounding applied coating composition, the dusts remain in highly concentrated state on the surface of the article. Subsequently, a clear coating composition is applied thereon, and then heated and cured. As a result, the resulting cured coating film has an abnormal appearance thereon, i.e., aggregate due to agglomeration of luster color pigment, which is apparently different from the surrounding coating film.

Accordingly, the present inventors have found that addition of a water dispersion of a hydrophobic melamine resin having an average particle size within a range of from 20 to 300 nm; an organic alcohol solvent having a solubility in water within a range of from 0.01 to 5.0 wt % and a boiling point within a range of from 160 to 200° C.; and, if necessary, an organic glycol-ether solvent having a solubility in water within a range of from 0.01 to 5.0 wt % and a boiling point within a range of from 205 to 240° C. to a waterborne metallic color base coating composition in order to form a metallic color base coating film can significantly prevent the aggregate due to agglomeration of luster color pigment, since the dusts are to be miscible or easily diluted with the surrounding applied metallic color base coating composition. Consequently, the present invention provides first embodiment as follows.

A method for producing a multi layered coating film, which comprises steps of:

applying an intermediate coating composition on an article to form an intermediate coating thereon;

applying a metallic color base coating composition on the intermediate coating to form a metallic color base coating thereon; and

applying a clear coating composition on the metallic color base coating to form a clear coating thereon;

wherein

the metallic color base coating composition is waterborne and comprises
an acryl emulsion resin;
a water dispersion of a hydrophobic melamine resin having an average particle size within a range of from 20 to 300 nm;
a luster color pigment; and
an organic alcohol solvent having a solubility in water within a range of from 0.01 to 5.0 wt % and a boiling point within a range of from 160 to 200° C., which is comprised within a range of from 5 to 45 wt % relative to solid resin content of the coating composition as a basis of weight; and
   wherein

the water dispersion of a hydrophobic melamine resin is obtained/obtainable by a method comprising steps of:
mixing an acryl resin and a hydrophobic melamine resin in a weight ratio of the acryl resin to the hydrophobic melamine resin within a range of a ratio of from 5/95 to 25/75 [acryl resin/hydrophobic melamine resin (as a basis of solid content)], wherein the acryl resin has an acid value within a range of from 105 to 200 mgKOH/g, a hydroxyl value within a range of from 50 to 200 mgKOH/g and a number average molecular weight within a range of from 1000 to 5000; and
reacting the acryl resin and the hydrophobic melamine resin at a temperature within a range of from 70 to 100° C. for 1 to 10 hours.

The above-described method for producing the multi layered coating film, wherein the acryl emulsion resin is obtained/obtainable by an emulsion polymerization of a mixture of α,β-ethylenically unsaturated monomers, wherein the mixture comprises no less than 65 wt % of a (meth)acrylate having an ester moiety having 1 or 2 carbon atoms and the mixture has an acid value of within a range of from 3 to 50 mgKOH/g.

The above-described method for producing the multi layered coating film, wherein the waterborne metallic color base coating composition further comprises an organic glycol-ether solvent having a solubility in water within a range of from 0.01 to 5.0 wt % and a boiling point within a range of from 205 to 240° C., which is comprised within a range of from 5 to 45 wt % relative to solid resin content of the coating composition as a basis of weight.

The above-described method for producing the multi layered coating film, wherein a weight ratio of the organic alcohol solvent to the organic glycol-ether solvent is within a range of a ratio of from 1/1 to 3/1 [organic alcohol solvent/organic glycol-ether solvent].

The waterborne metallic color base coating composition to be used in the above-described method for producing the multi layered coating film.

In addition, the present inventors have intensively investigated to achieve the second object. As a result, the present inventors have found that addition of a surfactant comprising a reaction product obtained/obtainable by a reaction of (a1) a nonreducing disaccharide or trisaccharide with (a2) an alkyleneoxide having 2 to 4 carbon atoms to a waterborne metallic color base coating composition can suppress and/or prevent skinning of the coating composition and aggregate due to agglomeration. Consequently, the present invention further provides second embodiment as follows.

A method for producing a multi layered coating film, which comprises steps of:

applying an intermediate coating composition on an article to form an intermediate coating thereon;

applying a metallic color base coating composition on the intermediate coating to form a metallic color base coating thereon; and

applying a clear coating composition on the metallic color base coating to form a clear coating thereon;

wherein

the metallic color base coating composition is waterborne and comprises
an acryl emulsion resin;
a curing agent of a melamine resin;
a luster color pigment;
a surfactant comprising a reaction product obtained/obtainable by a reaction of (a1) a nonreducing disaccharide or trisaccharide and (a2) an alkyleneoxide having 2 to 4 carbon atoms; and
an organic alcohol solvent having a solubility in water within a range of from 0.01 to 5.0 wt % and a boiling point within a range of from 160 to 200° C., and/or an organic glycol-ether solvent having a solubility in water within a range of from 0.01 to 5.0 wt % and a boiling point within a range of from 205 to 240° C., each of which is comprised within a range of from 5 to 45 wt % relative to solid resin content of the coating composition as a basis of weight.

The above-described method for producing the multi layered coating film, wherein the acryl emulsion resin is obtained/obtainable by an emulsion polymerization of a mixture of α,β-ethylenically unsaturated monomers, wherein the mixture comprises no less than 65 wt % of a (meth)acrylate having an ester moiety having 1 or 2 carbon atoms and the mixture has an acid value of within a range of from 3 to 50 mgKOH/g.

The above-described method for producing the multi layered coating film, wherein the surfactant is obtained/obtainable by a reaction of 1 mol of the nonreducing disaccharide or trisaccharide (a1) and 47 to 100 mol of the alkyleneoxide having 2 to 4 carbon atoms (a2).

The above-described method for producing the multi layered coating film, wherein a weight ratio of the organic alcohol solvent to the organic glycol-ether solvent is within a range of a ratio of from 1/1 to 3/1 [organic alcohol solvent/organic glycol-ether solvent].

The waterborne metallic color base coating composition to be used in the above-described method for producing the multi layered coating film.

### Effect of the Invention

The present invention, in particular, the first embodiment can provide a method for producing a multi layered coating film which can prevent aggregate due to agglomeration of luster color pigment as well as a waterborne metallic color base coating composition applicable to the method.

In addition, the present invention, in particular, the second embodiment can suppress and/or prevent skinning of waterborne metallic color coating composition and aggregate due to agglomeration, and provide a multi layered coating film having an excellent appearance.

### BRIEF DESCRIPTION OF THE DRAWINGS

FIG. 1 is a schematic view of a circulation tank and a circulation system for a coating composition.

### EXPLANATIONS OF LETTERS OR NUMERALS

1 Coating composition

2 Circulation tank

3 Stirring means

4 Circulation pump

5 Tube

6 Coating means

7 Tube

8 Filtration device

9 Filtration device

S1 Upper surface (line) of coating composition

S2 Surface (line) of coating composition

S3 Lower surface (line) of coating composition

### DETAILED DESCRIPTION OF THE INVENTION

### DETAILED DESCRIPTION OF THE PREFERRED EMBODIMENTS

The present invention relates to a method for producing a multi layered coating film wherein an intermediate coating film, a metallic color base coating film and a clear coating film are formed in this order on an article to be coated. The method for producing a multi layered coating film according to the present invention is characterized in components to be contained in waterborne metallic color base coating composition which can form a metallic color base coating film. Particularly, the first embodiment is characterized in a water dispersion of a hydrophobic melamine resin and a specific organic solvent to be added to the coating composition, which can significantly prevent aggregate due to agglomeration of luster color pigment. The second embodiment is characterized in a surfactant to be added to the coating composition, which can suppress and/or prevent skinning of the coating composition and aggregate due to agglomeration. Hereinafter, the article to be coated, the intermediate coating composition which can form the intermediate coating film, the waterborne metallic color base coating composition which can form the metallic color base coating film, and the clear coating composition which can form the clear coating film are described in detail.

Article to be Coated

According to the present invention, the article to be coated includes, but is not particularly limited to, for example, metal articles, plastic articles and foams thereof, etc.

Materials for the metal articles include, but are not particularly limited to, for example, metals such as iron, steel, copper, aluminum, tin and zinc, and alloys containing at lease one of these metals, etc. Specific examples of these metal articles include bodies and parts for vehicles such as automobiles, tracks, auto-bicycles, buses, etc. Particularly preferably, these metal articles may be chemically treated with a chemical conversion agent such as phosphate or chromate in advance of the coating.

Herein, as an article to be coated, a metal article, particularly, an article made of a metal or a cast product, each of which has a metal surface is particularly preferable, since an electrodeposition coating is possible thereon as an undercoat coating. An electrodeposition coating composition to form an electrodeposition coating film, which may be formed as the undercoat coating film, includes, but is not particularly limited to, cationic and anionic electrodeposition coating compositions. The cationic electrodeposition coating composition is preferable, since the cationic electrodeposition coating composition can provide a coating film having an excellent corrosion resistance.

Materials for the plastic articles include, but are not particularly limited to, for example, polypropylene resins, polycarbonate resins, urethane resins, polyester resins, polystyrene resins, ABS resins, vinyl chloride resins, polyamide resins, etc. Specifically, the plastic articles include, for example, vehicle parts such as spoilers, bumpers, mirror covers, grilles, door knobs, etc. It is more preferable that these plastic articles can be washed with pure water and/or a neutral detergent in advance of the coating. These plastic articles may be subjected to a conductive primer coating.

Intermediate Coating Composition

An intermediate coating film can be formed on the above-described article. An intermediate coating composition can be employed in order to form an intermediate coating film. The intermediate coating composition comprises a film forming resin, a curing agent, and a pigment such as various organic and inorganic coloring pigments and filler pigments, etc.

The film forming resin to be comprised in the above-described intermediate coating composition includes, but is not particularly limited to, for example, film forming resins such as an acryl resin, a polyester resin, an alkyd resin, an epoxy resin and a urethane resin. These resins may be used, in a combination, with a curing agent which is described below in the waterborne metallic color base coating composition. As a curing agent, generally, an amino resin and/or a (block) isocyanate resin can be employed in consideration of properties of the resulting coating film and their costs.

As a pigment, the pigment referred to in the explanation of the waterborne metallic color base coating composition below can be employed in this intermediate coating composition as well. Generally, there can be used a gray intermediate coating composition which predominantly comprises carbon black and titanium dioxide as pigments; a set gray intermediate coating composition which has a matched brightness with that of overcoat coating thereon; and a so-called color intermediate coating composition which comprises various coloring pigments in a combination. The intermediate coating composition may further comprise a flat pigment such as aluminum powder, mica, talc powder, etc.

In addition to the above-described components, the intermediate coating composition may further comprise an additive, which can be conventionally added to the coating composition, such as a surface conditioner, a thickener, an antioxidant, a ultraviolet inhibitor, a defoaming agent, etc.

A method for preparing the intermediate coating composition includes, but is not particularly limited to, for example, methods known to those skilled in the art to prepare the intermediate coating composition. Herein, the intermediate coating composition includes any commercially available intermediate coating compositions.

Waterborne Metallic Color Base Coating Composition

### First Embodiment

The waterborne metallic color base coating composition, which can be employed in the method for producing a multi layered coating film according to the first embodiment of the present invention (hereinafter referred to as first embodiment), and which can form a metallic color base coating film, is characterized in that the coating composition comprises an acryl emulsion resin, a water dispersion of a hydrophobic melamine resin having an average particle size within a range of from 20 to 300 nm, a pigment, and a specific organic alcohol solvent described below in detail, and if necessary, a specific organic glycol-ether solvent described below in detail.

Acryl Emulsion Resin

The acryl emulsion resin is obtained/obtainable by an emulsion polymerization of a mixture of α,β-ethylenically unsaturated monomers.

The mixture of α,β-ethylenically unsaturated monomers comprises no less than 65 wt % of a (meth)acrylate having an ester moiety having one or two carbon atoms. When the content is less than 65 wt %, appearance of the resulting coating is deteriorated. The (meth)acrylate having an ester moiety having one or two carbon atoms includes methyl(meth)acrylate and ethyl(meth)acrylate. The term “(meth)acrylate” as used herein means an acrylate or a methacrylate.

The mixture of α,β-ethylenically unsaturated monomers and the resulting acryl emulsion resin has an acid value of within a range of from 3 to 50 mgKOH/g, and preferably within a range of from 7 to 40 mgKOH/g. When the acid value is less than 3 mgKOH/g, the application workability in coating will become unsatisfactory. When the acid value exceeds 50 mgKOH/g, water resistance of the resulting coating will be deteriorated. Herein, the mixture of α,β-ethylenically unsaturated monomers and the resulting acryl emulsion resin have a hydroxyl value within a range of from 10 to 150 mgKOH/g, and preferably within a range of from 20 to 100 mgKOH/g. When the hydroxyl value is less than 10 mgKOH/g, no improvement in curability may possibly be attained. When the hydroxyl value exceeds 150 mgKOH/g, water resistance of the resulting coating may possibly be poor. It is also preferable that the polymer obtained/obtainable by a copolymerization of the α,β-ethylenically unsaturated monomers in the mixture has a glass transition temperature within a range of from −20 to 80° C., since the resulting coating will have improved mechanical characteristics.

The mixture of the α,β-ethylenically unsaturated monomers and the resulting acryl emulsion resin may comprise an α,β-ethylenically unsaturated monomer having an acid group or an hydroxyl group in order to adjust the acid value and the hydroxyl value within the range described above.

The α,β-ethylenically unsaturated monomer having an acid group includes acrylic acid, methacrylic acid, crotonic acid, 2-acryloyloxyethylphthalic acid, 2-acryloyloxyethylsuccinic acid, ω-carboxy-polycaprolactone mono(meth)acrylate, isocrotonic acid, α-hydro-ω-[(1-oxo-2-propenyl)oxy]poly[oxy(1-oxo-1,6-hexanediyl)], maleic acid, fumaric acid, itaconic acid, 3-vinylsalicylic acid, 3-vinylacetylsalicylic acid, 2-acryloyloxyethyl acid phosphate, 2-acrylamide-2-methylpropane-sulfonic acid, etc. Among others, acrylic acid and methacrylic acid are preferable.

The α,β-ethylenically unsaturated monomer having a hydroxyl group includes hydroxyethyl(meth)acrylate, hydroxypropyl(meth)acrylate, hydroxybutyl(meth)acrylate, allyl alcohol, (meth)acrylalcohol, and the adducts of hydroxyethyl(meth)acrylate with ε-caprolactone. Preferred among them are hydroxyethyl(meth)acrylate, hydroxybutyl(meth)acrylate, and the adducts of hydroxyethyl(meth)acrylate with ε-caprolactone.

The mixture of the α,β-ethylenically unsaturated monomers may further comprise other α,β-ethylenically unsaturated monomer(s). The other α,β-ethylenically unsaturated monomer includes (meth)acrylate having an ester moiety having three or more carbon atoms (e.g., n-butyl(meth)acrylate, isobutyl(meth)acrylate, tert-butyl(meth)acrylate, 2-ethylhexyl(meth)acrylate, lauryl(meth)acrylate, phenyl(meth)acrylate, isobornyl(meth)acrylate, cyclohexyl(meth)acrylate, tert-butylcyclohexyl(meth)acrylate, dicyclopentadienyl(meth)acrylate, dihydrodicyclopentadienyl(meth)acrylate, etc.), polymerizable amide compounds (e.g., (meth)acrylamide, N-methylol(meth)acrylamide, N-butoxymethyl(meth)acrylamide, N,N-dimethyl(meth)acrylamide, N,N-dibutyl(meth)acrylamide, N,N-dioctyl(meth)acrylamide, N-monobutyl(meth)acrylamide, N-monooctyl(meth)acrylamide, 2,4-dihydroxy-4′-vinylbenzophenone, N-(2-hydroxyethyl)acrylamide, N-(2-hydroxyethyl)methacrylamide, etc.), polymerizable aromatic compounds (e.g., styrene, α-methylstyrene, tert-butylstyrene, parachlorostyrene, vinylnaphthalene, etc.), polymerizable nitrites (e.g., acrylonitrile, methacrylonitrile, etc.), α-olefins (e.g., ethylene, propylene, etc.), vinyl esters (e.g., vinyl acetate, vinyl propionate, etc.), and dienes (e.g., butadiene, isoprene, etc.). One or more appropriate ones may be selected from among these according to the intended purpose of use thereof. Use of (meth)acrylamide is preferable in order to facilitate provision of hydrophilicity.

Herein, it is necessary that the content, in the α,β-ethylenically unsaturated monomer mixture, of the above-described α,β-ethylenically unsaturated monomer(s) other than the (meth)acrylate having an ester moiety having one or two carbon atoms should be selected at a level of less than 35 wt %.

The above-described acryl emulsion resin contained in the waterborne metallic color base coating composition according to the present invention is a resin obtained/obtainable by an emulsion polymerization of the above-described α,β-ethylenically unsaturated monomers in the mixture. The emulsion polymerization as used herein includes, but is not particularly limited to, the conventional methods generally known to those skilled in the art. Specifically, the emulsion polymerization can be carried out, for example, by dissolving an emulsifier in water or, if necessary, in an aqueous medium containing an organic solvent such as an alcohol and ether (e.g., dipropyleneglycol methyl ether, propyleneglycol methyl ether, and the like); and then thereto adding dropwise the above-described α,β-ethylenically unsaturated monomer mixture and a polymerization initiator with heating and stirring. The α,β-ethylenically unsaturated monomer mixture may be added dropwise thereto in the form of an emulsion previously prepared with an emulsifier and water, as well.

Among others, the preferable polymerization initiator includes, for example, oil-soluble azo compounds (e.g., azobisisobutyronitrile, 2,2′-azobis(2-methylbutyronitrile), 2,2′-azobis(2,4-dimethylvaleronitrile), etc.) and water-soluble azo compounds (e.g., anionic 4,4′-azobis(4-cyanovaleric acid), 2,2-azobis(N-(2-carboxyethyl)-2-methylpropionamidine, and cationic 2,2′-azobis(2-methylpropionamidine)); as well as oil-soluble peroxides in redox systems (e.g., benzoyl peroxide, parachlorobenzoyl peroxide, lauroyl peroxide, tert-butyl perbenzoate, tert-butylperoxy-2-ethylhexanoate, etc.) and water-soluble peroxides (e.g., potassium persulfate, ammonium persulfate, etc.) in redox systems, etc.

The emulsifier as used herein includes any of those conventionally known to those skilled in the art. Among others, preferable emulsifier includes reactive emulsifiers such as Antox MS-60 (produced by Nippon Nyukazai), Eleminol JS-2 (produced by Sanyo Chemical Industries), Adeka Reasoap NE-20 (produces by Asahi Denka Kogyo: α-[1-[(allyloxy)methyl]-2-(nonylphenoxy)ethyl]-ω-hydroxyoxyethylene), Aqualon HS-10 (produced by Dai-ichi Kogyo Seiyaku: polyoxyethylenealkyl propenylphenyl ether sulfate), etc.

Herein, if necessary, a chain transfer agent such as a mercaptan (e.g., laurylmercaptan) and α-methylstyrene dimer may be employed in order to adjust molecular weight of the resulting resin.

The reaction temperature can be determined depending on the initiator. It is generally within a range of from 40 to 180° C. For example, with respect to the azo initiator, it is preferably within a range of from 60 to 90° C. With respect to the initiator in the redox system, it is preferably within a range of from 30 to 70° C. The reaction time is generally within a range of from 1 to 8 hours. The content of the initiator relative to the total weight of the α,β-ethylenically unsaturated monomer mixture is generally within a range of from 0.1 to 5 wt %, preferably within a range of from 0.2 to 2 wt %.

The above-described emulsion polymerization can be carried out in a multi-stage procedure, for example, a two-step procedure. Herein, a portion of the α,β-ethylenically unsaturated monomer mixture (hereinafter, which is also referred to as “α,β-ethylenically unsaturated monomer mixture 1”) can be initially subjected to an emulsion polymerization to provide an emulsion; and then thereto the remaining portion of the α,β-ethylenically unsaturated monomer mixture (hereinafter, which is also referred to as “α,β-ethylenically unsaturated monomer mixture 2”) can be further added and subjected to the emulsion polymerization.

Herein, in order to improve miscibility to the resulting clear coating thereon, it is preferred that the α,β-ethylenically unsaturated monomer mixture 1 contains an α,β-ethylenically unsaturated monomer having an amide group. Herein, it is more preferred that the α,β-ethylenically unsaturated monomer mixture 2 be free of any α,β-ethylenically unsaturated monomer having an amide group. Since the above-described α,β-ethylenically unsaturated monomer mixture consists in the α,β-ethylenically unsaturated monomer mixture 1 and the α,β-ethylenically unsaturated monomer mixture 2, the above-defined requirements with respect to the α,β-ethylenically unsaturated monomer mixture should be adapted to a combination of the α,β-ethylenically unsaturated monomer mixture 1 and α,β-ethylenically unsaturated monomer mixture 2.

It is preferable that the resulting acryl emulsion resin has an average particle size within a range of from 0.01 to 1.0 μm. When the average particle size is less than 0.01 μm, an improvement of application workability for application of the resulting coating composition will be decreased. When the average particle size exceeds 1.0 μm, appearance of the resulting coating may be deteriorated. It is more preferable that the resulting acryl emulsion resin has an average particle size within a range of from 0.05 to 0.5 μm. The average particle size can be adjusted, for example, by controlling the monomer formulation and/or emulsion polymerization conditions. Herein, the average particle size means a volume average particle size which can be determined by a laser light scattering method.

The above-described acryl emulsion resin may have pH within a range of from 5 to 10, if necessary, after neutralizing with a basic substance. This owes to the fact that the resin is highly stable in this pH range. This neutralization is preferably carried out by adding a tertiary amine such as dimethylethanolamine (i.e., dimethylaminoethanol) and triethylamine to the emulsion system before or after the emulsion polymerization.

The content of the above-described acryl emulsion resin in the waterborne metallic color base coating composition according to the present invention (as a basis of weight, i.e., in wt %) is within a range of from 20 to 60 wt %, preferably within a rang of from 30 to 50 wt %, and more preferably within a range of from 35 to 45 wt % relative to weight of solid resin content of the waterborne metallic color base-coating composition.

When the content of the acryl emulsion resin is less than 20 wt %, there may be problems such that the application workability for application of the resulting coating composition will be decreased. When the content of the acryl emulsion resin is more than 60 wt %, there may be problems such that characteristics and performances of the resulting coating will be decreased.

Water Dispersion of hydrophobic melamine resin

According to the present invention, the water dispersion of the hydrophobic melamine resin comprises a water dispersion of a hydrophobic melamine resin having an average particle size within a range of from 20 to 300 nm. The water dispersion is obtained/obtainable by a method including steps of reacting a specific acrylic resin with a hydrophobic melamine resin to provide a reaction product; and dispersing the resulting reaction product into water. The waterborne metallic color base coating composition according to the present invention comprises such water dispersion of the hydrophobic melamine resin. Therefore, the resulting coating has a superior color property. When the average particle size is less than 20 nm, the solid content of the coating composition is remarkably lowered. When the average particle size exceeds 300 nm, the dispersibility into water will be decreased, and therefore, there may be a fear that the adherence property and the surface smoothness of the resulting coating film will be decreased. The average particle size is preferably within a range of from 30 to 250 nm, and more preferably within a range of from 100 to 200 nm. Herein, the above-described average particle size can be determined by a method similar to that described in the average particle size of the above-described acrylic emulsion resin.

The above-described water dispersion of the hydrophobic melamine resin can be prepared by a method including steps of mixing a hydrophobic melamine resin and an acryl resin having an acid value within a range of from 105 to 200 mgKOH/g, a hydroxyl value within a range of from 50 to 200 mgKOH/g and a number average molecular weight within a range of from 1000 to 5000 in a weight ratio of the acryl resin to the hydrophobic melamine resin (the acryl resin/the hydrophobic melamine resin) within a range of a ratio of from 5/95 to 25/75 as a basis of the solid content; and reacting them at a temperature within a range of from 70 to 100° C. for one to ten hours. Specifically, preferable water dispersion of the hydrophobic melamine resin can be prepared by a production method including steps of:

Step (1) of mixing and/or reacting a hydrophobic melamine resin with an acryl resin having an acid value within a range of from 105 to 200 mgKOH/g (as a basis of solid resin content), a hydroxyl value within a range of from 50 to 200 mgKOH/g (as a basis of solid resin content) and a number average molecular weight within a range of from 1000 to 5000; and

Step (2) of dispersing the resulting reaction product from the Step (1) into water to give a water dispersion, i.e., aqueous dispersion. Thereby, the color property, recoat adhesion, chipping resistance and adhesion after water-resistant test of the resulting coating can be improved.

When the acid value of the acryl resin is less than 105 mgKOH/g, the average particle size will be larger, and therefore, there may be a fear that storage stability of the resin added in the resulting coating composition will be deteriorated. When the acid value of the acryl resin is more than 200 mgKOH/g, there may be a fear that control of the reaction will be terribly difficult. It is preferable that the acid value is within a range of from 105 to 180 mgKOH/g. When the hydroxyl value of the acryl resin is less than 50 mgKOH/g, the average particle size will be larger, and therefore, there may be a fear that storage stability of the resin added in the resulting coating composition will be deteriorated. When the hydroxyl value is more than 200 mgKOH/g, there may be a fear that control of the reaction will be terribly difficult. It is preferable that the hydroxyl value is within a range of from 60 to 180 mgKOH/g. When the number average molecular weight of the acryl resin is less than 1000, the average particle size will be larger, and therefore, there may be a fear that storage stability of the resin added in the resulting coating composition will be deteriorated. When the number average molecular weight is more than 5000, there may be a fear that control of the reaction will be terribly difficult. It is preferable that the number average molecular weight is within a range of from 1500 to 4000. Herein, the number average molecular weight of the acryl resin can be measured by a gel permeation chromatography (GPC) with polystyrene having a known molecular weight as a standard.

The above-described acryl resin can be prepared by a polymerizing method known to those skilled in the art such as an emulsion polymerization, which includes a step of, for example, subjecting a monomer composition comprising a carboxylic acid group-containing unsaturated monomer and a hydroxyl group-containing unsaturated monomer, and if necessary, other ethylenically unsaturated monomer to a polymerization, in the water-soluble organic solvent, for example, in the presence of a polymerization initiator known to those skilled in the art (e.g., tert-butylperoxy 2-ethylhexanoate, and the like) and/or a emulsifier known to those skilled in the art (e.g., methylpropylenediglycol, and the like), etc.

The above-described carboxylic acid group-containing unsaturated monomer includes, but is not particularly limited to, for example, acrylic acid, methacrylic acid, crotonic acid, 2-acryloyloxyethyl phthalate, 2-acryloyloxyethyl succinate, 2-acryloyloxyethyl acid phosphate, 2-acrylamide-2-methylpropane sulfonate, ω-carboxy-polycaprolactone mono(meth)acrylate, isocrotonic acid, α-hydro-ω-[(1-oxo-2-propenyl)oxy]-poly[oxy(1-oxo-1,6-hexanediyl)], maleic acid, fumaric acid, itaconic acid, 3-vinylsalicilic acid, 3-vinylacetylsalicylic acid, etc.

The above-described hydroxyl group-containing unsaturated monomer includes, but is not particularly limited to, for example, hydroxyethyl(meth)acrylate, hydroxypropyl(meth)acrylate, hydroxybutyl(meth)acrylate, allyl alcohol, (meth)acryl alcohol, and the adduct of hydroxyethyl(meth)acrylate with ε-caprolactone. Among others, hydroxyethyl(meth)acrylate, hydroxybutyl(meth)acrylate, the adduct of hydroxyethyl(meth)acrylate with ε-caprolactone, and the like are preferable.

The above-described other ethylenically unsaturated monomer includes, but is not particularly limited to, for example, (meth)acrylate ester wherein the ester portion has 1 or 2 carbon atoms [i.e., methyl(meth)acrylate and ethyl(meth)acrylate]; (meth)acrylate ester wherein the ester portion has 3 or more carbon atoms [e.g., n-butyl(meth)acrylate, isobutyl(meth)acrylate, tert-butyl(meth)acrylate, 2-ethylhexyl(meth)acrylate, lauryl(meth)acrylate, phenyl(meth)acrylate, isobornyl(meth)acrylate, cyclohexyl(meth)acrylate, tert-butylcyclohexyl(meth)acrylate, dicyclopentadienyl(meth)acrylate, dihydrodicyclopentadienyl(meth)acrylate, and the like], polymerizable amido compounds [e.g., (meth)acrylamide, N-methylol(meth)acrylamide, N-butoxymethyl(meth)acrylamide, N,N-dimethyl(meth)acrylamide, N,N-dibutyl(meth)acrylamide, N,N-dioctyl(meth)acrylamide, N-monobutyl(meth)acrylamide, N-monooctyl(meth)acrylamide, 2,4-dihydroxy-4′-vinylbezophenone, N-(2-hydroxyethyl)acrylamide, N-(2-hydroxyethyl)methacrylamide, and the like]; polymerizable aromatic compounds [e.g., styrene, α-methylstyrene, tert-butylstyrene, para-chlorostyrene, vinylnaphthalene, and the like]; polymerizable nitrites [e.g., acrylonitrile, methacrylonitrile, and the like]; α-olefins [e.g., ethylene, propylene, and the like]; and vinyl esters [e.g., vinyl acetate, vinyl propionate, and the like], dienes [e.g., butadiene, isoprene, and the like], etc.

The above-described hydrophobic melamine resin includes a conventional melamine resin known to those skilled in the art. It is preferable that the hydrophobic melamine resin has a solubility parameter δ (SP value) within a range of from 9.0 to 11.5 [9.0≦SP≦11.5], more preferably within a range of from 9.5 to 11.0 [9.5≦SP≦11.0]. When the SP value is less than 9.0, there may be a fear that the average particle size of the resulting resin will be more than 300 nm. When the SP value is more than 11.5, there may be fears that the average particle size of the resulting resin will also be more than 300 nm and coating characteristics of the resulting coating composition such as water resistance will be deteriorated.

The solubility parameter δ (SP value) is an index of hydrophilicity and hydrophobicity of a resin, which is a key factor in determining miscibility between resins. Generally, measurement for a solubility parameter δ (SP value) of a resin is known to those skilled in the art in the art, wherein a resin is dissolved in a good solvent having a given solubility parameter δ (SP value) to give a solution, the solution can be subjected to turbidimetric titration with a poor solvent having a given higher SP value than that of the good solvent, and/or with a poor solvent having a given lower SP value than that of the good solvent to determine a SP value of the resin (see Reference 1: C. M. Hansen, J. Paint. Tech., 39 [505], 104 (1967) and Reference 2: “Color materials (SHIKIZAI)” by Toshikatsu Kobayashi, 77 [4], 188-192 (2004)).

For example, a solubility parameter δ (SP value) can be determined with a sample, a good solvent and a poor solvent by a turbidimetric titration at a measuring temperature of 20° C., which are described below in detail.

Sample: 0.5 g of a resin is weighed in a 100 ml beaker, 10 ml of a good solvent is added to the beaker with a whole pipette, and then the resin is dissolved in the solvent with a magnetic stirrer to give a resin sample to be measured.

Good solvent: Acetone (SP value (δg) (measured by a Hansen method (see Reference 1)): 9.77

Poor solvent: Hexane (SP value (δpl) (measured by a Hansen method (see Reference 1): 7.24 (i.e., a lower SP value) or deionized water (SP value (δph) (measured by a Hansen method (see Reference 1): 23.50 (i.e., a higher SP value))

Turbidimetric Titration

Poor solvent, herein which is hexane, is added dropwise to the sample with a 50 ml burette, and then at a point wherein turbidity is generated, the amount of the added hexane (i.e., the titration amount) is recorded. The volume proportion of the added hexane (φpl) can be determined by the following formula:

φpl=(amount of added hexane at a point wherein turbidity is generated)/((amount of added hexane at a point wherein turbidity is generated)+(amount of good solvent)).

Subsequently, poor solvent, herein which is deionized water, is added dropwise to a sample with a 50 ml burette, and then at a point wherein turbidity is generated, the amount of the added deionized water (i.e., the titration amount) is recorded. The volume proportion of the added deionized water (φph) can be determined by the following formula: φph=(amount of added deionized water at a point wherein turbidity is generated)/((amount of added deionized water at a point wherein turbidity is generated)+(amount of good solvent)).

The SP values δml and δmh can be respectively determined by the following equations (1) and (2), wherein the SP value (δml) is a volume of the added hexane at a point turbidity is generated by the addition of hexane (i.e., SP value of the hexane containing mixture) and the SP value (δmh) is a volume of the added deionized water at a point turbidity is generated by the addition of deionized water (i.e., SP value of the deionized water containing mixture)).

SP value of the resin (δpoly) is an average value of the SP values (δml and δmh), which can be determined by the following equation (3):

δml=φpl δpl+(1−φpl)δg (1)

δmh=φph δph+(1−φph)δg (2)

δpoly=(δml+δmh)/2 (3)

It is preferable that the above-described step (1) includes a step of mixing the above-described acryl resin and the above-described hydrophobic melamine resin in a weight ratio of the acryl resin to the hydrophobic melamine resin (the acryl resin/the hydrophobic melamine resin) within a range of a ratio of from 5/95 to 25/75, and more preferably within a range of a ratio of from 10/90 to 20/80 as a basis of the solid content. The above-described step (1) can provide a reaction product of the acryl resin with the hydrophobic melamine resin. When the weight ratio is less than 5/95, i.e., when the amount of the acryl resin to be added is smaller, there may be a fear that the average particle size will be more than 300 nm. When the weight ratio is more than 25/75, i.e., when the amount of the acryl resin to be added is larger, there may be fears that a terrible decrease in the non-volatile (NV) (i.e., solid) content in the coating composition will occur and control of the reaction will have a terrible difficulty.

Herein, the procedure for mixing the acryl resin and the hydrophobic melamine resin includes a conventional method known to those skilled in the art, which includes a step, for example, previously mixing the hydrophobic melamine resin and the acryl resin, wherein the acryl resin is in an organic solvent such as dipropyleneglycol methyl ether, or the like (i.e., as a solvent type acryl resin) to give a homogenous mixture. Preferably, subsequent addition of a basic substance such as an amine (e.g., dimethylethanolamine, or the like), a surfactant or the like to the mixture can provide a water dispersion, wherein the acryl resin can act as a protective resin for the hydrophobic melamine resin. It is desirable that the melamine resin particles in the resulting dispersion have excellent stability.

According to the present invention, the amount of the acrylic resin to be added to the hydrophobic melamine resin is small in the step (1). Therefore, in the case that the resulting water dispersion of the hydrophobic melamine resin is used as a curing agent, the function as a curing agent is hardly lowered. In addition, nevertheless the amount of the acrylic resin to be added is small, the average particle size after water-dispersing is within a range of from 20 to 300 nm. Consequently, the resulting water dispersion of the hydrophobic melamine resin according to the present invention can be preferably employed as a curing agent in the waterborne metallic color base coating composition. Furthermore, in the step (1), the other resin(s) such as a polyester resin may be added to the waterborne metallic color base coating composition in addition to the above-described acrylic resin and the above-described hydrophobic melamine resin to an extent not adversely effecting on the improvements provided by the present invention.

In the step (1), the conditions for the reaction of the above-described acrylic resin with the above-described hydrophobic melamine resin are as follows. The reaction temperature is within a range of from 70 to 100° C., and preferably within a range of from 75 to 90° C. In addition, the reaction time is preferably within a range of from 1 to 10 hours, and more preferably within a range of from 1 to 5 hours. When the reaction temperature or the reaction time is less than the lower limit, there may be a fear that the average particle size exceeds 300 nm. When the reaction temperature or the reaction time exceeds the upper limit, there may a fear that the reaction control is remarkably difficult.

The above-described mixing with heating (hereinafter, which is also referred to as hot blending) can provide a reaction product of the above-described acryl resin with the above-described hydrophobic melamine resin, wherein the reaction product is partially crosslinked, or crosslinked to some extent. The crosslinkage to some extent can provide the melamine resin having an invariable average particle size in the resulting dispersion and an excellent storage stability of the coating composition.

Mixing and dispersing of the above-described hydrophobic melamine resin can be carried out in a device such as a disper, a homomixer, a mill, in order to shorten the dispersing time and stabilize the resulting dispersion, to which, if necessary, an additive such as the above-described base substance such an amine and a surfactant may be added.

The step (2) includes a step of dispersing the resulting reaction product from the step (1) into water to provide a water dispersion of a hydrophobic melamine resin having an average particle size within a range of from 20 to 300 nm. The step (2) can provide a water dispersion (or an aqueous dispersion) in which resin particles having an average particle size within a range of from 20 to 300 nm are dispersed in water.

In the step (2), the method for dispersing the resulting reaction product from the step (1) into water includes, but is not specifically limited to, a conventional method for dispersing a resin into water. It is preferable that the reaction product is cooled to a temperature of 50° C. or less, and then water for dilution is added to provide a water dispersion. Accordingly, the water dispersion of the hydrophobic melamine resin having an average particle size within a range of from 20 to 300 nm can be preferably prepared. When it is not cooled at the temperature of 50° C. or less, there may be a fear that the water dispersion of the hydrophobic melamine resin having an average particle size within a range of from 20 to 300 nm cannot be obtained. It is more preferable that a water dispersion is prepared by adding water for dilution after cooling to a temperature of 30 to 40° C.

If necessary, the aqueous dispersion of the hydrophobic melamine resin may be neutralized with a base substance such as an amine (e.g., dimethylethanolamine, or the like) in the step (2), and the water dispersion can be used at a pH within a range of from 5 to 10. The reason is that stability of the water dispersion of the hydrophobic melamine resin in this pH range is high. It is preferable that the neutralization is carried out by adding a tertiary amine (e.g., dimethylethanolamine, triethylamine, or the like) into the reaction system before or after the reaction of the above-described acrylic resin with the above-described hydrophobic melamine resin. Among others, it is particularly preferable that the tertiary amine is added after the reaction of the above-described acrylic resin with the above-described hydrophobic melamine resin, and then the water dispersion is obtained by the addition of water for dilution after cooling the reaction product to the temperature of 50° C. or less. Thereby, the water dispersion of the hydrophobic melamine resin having an average particle size within a range of from 20 to 300 nm can be preferably prepared.

In addition to the above-described curing agent, the curing agent includes other curing agent, which is a conventional in the art of the coating compositions, such as a block isocyanate resin, an epoxy compound, an aziridine compound, a carbodiimide compound, an oxazoline compound, a metal ion, etc.

Content of the above-described other curing agent is preferably within a range of from 0 to 40 wt %, and more preferably within a range of from 1 to 35 wt %, relative to solid resin content of the waterborne metallic color base coating composition as a basis of weight. When the content is more than 40 wt %, the resulting coating will be excessively hardened and embrittled.

Content of the above-described water dispersion of the hydrophobic melamine resin in the waterborne metallic color base coating composition can be represented by a weight ratio of the hydrophobic melamine resin in the above-described dispersion to the total resin components in the coating composition (hydrophobic melamine resin/total resin components) preferably within a range of a ratio of from 10/90 to 50/50, and more preferably within a range of a ratio of from 25/75 to 45/55. When the ratio is less than 10/90, the resulting coating will have a deteriorated curability. When the ratio is more than 50/50, the resulting coating will be excessively hardened and embrittled.

The above-described waterborne metallic color base coating composition according to the present invention, if necessary, may comprise other film forming resin(s). The other film forming resin includes, but is not particularly limited to, a film forming resin such as a water-soluble acryl resin, a polyester resin, an alkyd resin, an epoxy resin, an urethane resin, etc.

The other film forming resin has a number average molecular weight within a range of from 3000 to 50000, and more preferably within a range of from 6000 to 30000. When the number average molecular weight is less than 3000, insufficient application workability and curability will be provided. When the number average molecular weight is more than 50000, non-volatile contents in the coating composition will be excessively decreased upon coating, and therefore, the application workability will be also decreased.

The other film forming resin has an acid value preferably within a range of from 10 to 100 mgKOH/g, and more preferably within a range of from 20 to 80 mgKOH/g. When the acid value is more than 100 mgKOH/g, water resistance of the resulting coating will be decreased. When the acid value is less than 10 mgKOH/g, dispersibility of the resin into the water will be decreased. In addition, the other film forming resin has a hydroxyl value preferably within a range of from 20 to 180 mgKOH/g, and more preferably within a range of from 30 to 160 mgKOH/g. When the hydroxyl value is more than 180 mgKOH/g, water resistance of the resulting coating will be decreased. When the hydroxyl value is less than 20 mgKOH/g, curability of the resulting coating will be decreased.

Pigments

The pigment to be used in the present invention includes a luster color pigment and a coloring pigment. The preferable luster color pigment includes, but is not particularly limited on its shape to, for example, a luster color pigment having an average particle size (D₅₀) within a range of from 2 to 50 μm and a thickness within a range of from 0.1 to 5 μm, which may have been colored, more preferably a luster color pigment having an average particle size (D₅₀) within a range of from 10 to 35 μm in order to provide an excellent luster color. Specifically, the luster color pigment includes a luster color pigment made of a metal such as aluminum or aluminum oxide, copper, zinc, iron, nickel and tin, each of which may be colored, or an alloy thereof; and a combination thereof, etc. The luster color pigment further includes interference color mica pigments, white mica pigments, graphite pigments, etc. Herein, the average particle size of the luster color pigment can be determined by a laser light diffraction method.

Herein, the coloring pigment includes, but is not particularly limited to, for example, organic pigments, such as azo chelate pigments, insoluble azo pigments, condensed azo pigments, diketopyrrolopyrrole pigments, benzimidazolone pigments, phthalocyanine pigments, indigo pigments, perinone pigments, perylene pigments, dioxane pigments, quinacridone pigments, isoindolinone pigments, and metal complex pigments; inorganic pigments such as chrome yellow, yellow iron oxide, red iron oxide, carbon black and titanium dioxide; filler pigments such as calcium carbonate, barium sulfate, clay, talc, etc.

Concentration of the total pigments in the above-described waterborne metallic color base coating composition (i.e., pigment weight concentration (PWC)) is preferably within a range of from 0.1 to 50%, more preferably within a range of from 0.5 to 40%, and particularly preferably within a range of from 1.0 to 30%. The PWC is more than 50%, appearance of the resulting coating will be deteriorated. In the case that the above-described waterborne metallic color base coating composition includes the luster color pigment, generally, the pigment weight concentration (PWC) is preferably no more then 18.0%, more preferably within a range of from 0.01 to 15.0%, and particularly preferably within a range of from 0.01 to 13.0%. When the PWC is more than 18.0%, appearance of the resulting coating will be deteriorated.

Organic Solvent

The waterborne metallic color base coating composition according to the present invention comprises an organic alcohol solvent having a solubility in water within a range of from 0.01 to 5.0 wt % and a boiling point within a range of from 160 to 200° C., and if necessary, further comprises an organic glycol-ether solvent having a solubility in water within a range of from 0.01 to 5.0 wt % and a boiling point within a range of from 205 to 240° C. Herein, solubility is a percentage of weight of dissolved organic solvent to 100 parts by weight of water at 20° C.

When the solubility of the organic alcohol solvent into water is less than 0.01 wt %, there may be problems such as remarkable increase in viscosity of the coating composition, etc. When the solubility exceeds 5.0 wt %, there may be problems such as remarkable decrease in viscosity of the coating composition, decrease in application workability, etc. The solubility of the organic alcohol solvent into water is preferably within a range of from 0.05 to 3.0 wt %.

When the boiling point of the organic alcohol solvent is less than 160° C., there may be problems such as decrease in application workability, particularly in popping property, etc. When the boiling point exceeds 200° C., there may be problems such as decrease in application workability, particularly in sagging property, etc. The boiling point of the organic alcohol solvent is preferably within a range of from 170 to 190° C.

The above-described organic alcohol solvent (hereinafter, solubility and boiling point are listed in parentheses) is selected from the group consisting of heptanol (0.5 wt % and 168° C.), 2-ethylhexyl alcohol (0.1 wt % and 184° C.) and cyclohexanol (4.0 wt % and 161° C.). 2-ethylhexyl alcohol is preferable, since 2-ethylhexyl alcohol can stabilize the acryl emulsion resin and the water dispersion of the hydrophobic melamine resin (in their particle sizes).

The content of the organic alcohol solvent in the waterborne metallic color base coating composition is within a range of from 5 to 45 wt % relative to solid resin content of the waterborne metallic color base coating composition as a basis of weight. When the content is less than 5 wt %, there may be problems such as decrease in prevention effect to the aggregate due to agglomeration of luster color pigment, etc. When the content exceeds 45 wt %, there may be problems such as decrease in application workability, etc. For example, in such case, popping may be observed.

When the above-described organic alcohol solvent is added to the waterborne metallic color base coating composition, atomization at coating is improved. Therefore, the aggregate due to agglomeration of luster color pigment can be significantly prevented.

If necessary, the organic glycol-ether solvent having a solubility in water within a range of from 0.01 to 5.0 wt % and a boiling point within a range of from 205 to 240° C. may be added to the waterborne metallic color base coating composition according to the present invention.

When the solubility of the organic glycol-ether solvent into water is less than 0.01 wt %, there may be problems such as remarkable increase in viscosity of the coating composition, etc. When the solubility exceeds 5.0 wt %, there may be problems such as remarkable decrease in viscosity of the coating composition, decrease in application workability, etc. The solubility of the organic glycol-ether solvent into water is preferably within a range of from 0.05 to 3.0 wt %.

When the boiling point of the organic glycol-ether solvent is less than 205° C., there may be problems such as decrease in application workability, particularly in popping property, etc. When the boiling point exceeds 240° C., there may be problems such as decrease in application workability, particularly in sagging property, etc. The boiling point of the organic glycol-ether solvent is preferably within a range of from 210 to 230° C.

The above-described organic glycol-ether solvent (hereinafter, solubility and boiling point are listed in parentheses) is selected from the group consisting of ethylene glycol monohexyl ether (i.e., hexyl glycol, 1.0 wt % and 208° C.), ethylene glycol mono-2-ethylhexyl ether (i.e., 2-ethylhexyl glycol, 0.2 wt % and 225° C.) and dipropylene glycol monobutyl ether (5.0 wt % and 215° C.) Ethylene glycol mono-2-ethylhexyl ether is preferable, since Ethylene glycol mono-2-ethylhexyl ether can stabilize the acryl emulsion resin and the water dispersion of the hydrophobic melamine resin (in their particle sizes).

The content of the organic glycol-ether solvent in the waterborne metallic color base coating composition is within a range of from 5 to 45 wt % relative to solid resin content of the waterborne metallic color base coating composition as a basis of weight. When the content is less than 5 wt %, there may be problems such as decrease in the prevention effect to the aggregate due to agglomeration of luster color pigment, etc. When the content exceeds 45 wt %, there may be problems such as decrease in application workability, etc. For example, in such case, popping may be observed.

The addition of the above-described organic glycol-ether solvent to the waterborne metallic color base coating composition, in addition to the above-described organic alcohol solvent, can give advantages such as provision of excellent stability of the acryl emulsion resin and the water dispersion of the hydrophobic melamine resin (in their particle sizes).

When the waterborne metallic color base coating composition according to the present invention comprises both of the organic alcohol solvent and the organic glycol-ether solvent, weight ratio of the organic alcohol solvent to the organic glycol-ether solvent is within a range of a ratio of from 1/1 to 3/1 (organic alcohol solvent/organic glycol-ether solvent). When the weight ratio is less than 1/1, there may be problems such as decrease in viscosity of the coating composition, etc. For example, in such case, there may also be troubles in application workability. When the weight ratio exceeds 3/1, there may be problems such as temporal decrease in stability of the acryl emulsion resin and the water dispersion of the hydrophobic melamine resin, etc.

Alternatively, the organic glycol-ether solvent may be solely added to the waterborne metallic color base coating composition instead of the organic alcohol solvent.

In addition to the above-described components, the waterborne metallic color base coating composition according to the present invention may further comprises an additive, which may be usually added to the conventional coating composition, such as a surfactant, a dispersing agent, a surface conditioner, a viscosity conditioner, a thickener, an antioxidant, a ultraviolet inhibitor, a defoaming agent, a pH conditioner, etc.

Method for preparing the waterborne metallic color base coating composition includes, but is not particularly limited to, methods known to those skilled in the art, which can homogeneously disperse the above-described components, for example, methods employing an apparatus such as a kneader, a mill or a roll mill, etc.

As described above, the waterborne metallic color base coating composition according to the present invention comprises an organic alcohol solvent having a solubility in water within a range of from 0.01 to 5.0 wt % and a boiling point within a range of from 160 to 200° C., and if necessary, further comprises an organic glycol-ether solvent having a solubility in water within a range of from 0.01 to 5.0 wt % and a boiling point within a range of from 205 to 240° C. Therefore, the waterborne coating composition according to the present invention can significantly prevent generation of aggregate due to agglomeration of luster color pigment. In addition, introduction of hot blending step to the preparation of the water dispersion of the hydrophobic melamine resin can further suppress the aggregate due to agglomeration of luster color pigment.

Waterborne Metallic Color Base Coating Composition

### Second Embodiment

The waterborne metallic color base coating composition, which can be employed in the method for producing a multi layered coating film according to the second embodiment of the present invention (herein after referred to as second embodiment), and which can form a metallic color base coating film, is characterized in that the coating composition comprises an acryl emulsion resin, a curing agent of a melamine resin, a pigment, a specific surfactant described below in detail, and a specific organic alcohol solvent described below in detail and/or a specific organic glycol-ether solvent described below in detail. The specific surfactant can significantly suppress and/or prevent skinning of the waterborne metallic color base coating composition and aggregate due to agglomeration. Hereinafter, the respective components to be contained in the waterborne metallic color base coating composition according to the second embodiment of the present invention are described in detail.

Surfactant

The waterborne metallic color base coating composition according to the present invention comprises a surfactant comprising a reaction product obtained/obtainable by a reaction of (a1) a nonreducing disaccharide or trisaccharide and (a2) an alkyleneoxide having 2 to 4 carbon atoms, as a surfactant.

The reaction product obtained/obtainable by a reaction of (a1) a nonreducing disaccharide or trisaccharide (hereinafter, which is abbreviated and referred to as compound (a1)) and (a2) an alkyleneoxide having 2 to 4 carbon atoms (hereinafter, which is abbreviated and referred to as compound (a2)) includes, for example, a polyoxyalkylene compound (A) represented by the formula (1):

{H—(OA)ₙ-}ₘQ (1)

wherein

Q is a residue of the nonreducing disaccharide or trisaccharide (a1) wherein hydrogen atom is removed from the primary hydroxyl group wherein the number of the primary hydroxyl group is m,

OA is (a2) an oxyalkylene group having 2 to 4 carbon atoms,

n is an integer of from 1 to 100,

m is an integer of from 2 to 4,

{H—(OA)ₙ-} moieties may be the same or different and the number of the {H—(OA)ₙ-} moieties is m, and

the total number (n×m) of OA moieties is within a range of from 47 to 100,

etc.

The residue (Q) is a residue obtained/obtainable by removing hydrogen atom from the primary hydroxyl group of the nonreducing disaccharide or trisaccharide (a1) wherein the number of the primary hydroxyl group is m. Herein, secondary hydroxyl group, if any, seems to be in the residue without any association with the elimination reaction. The nonreducing disaccharide includes, but is not limited to, for example, any nonreducing disaccharides such as sucrose (saccharose), isosaccharose, trehalose, isotrehalose and the like. The nonreducing trisaccharide includes, but is not limited to, for example, any nonreducing trisaccharides such as gentianose, raffinose, melezitose, planteose and the like. Among others, sucrose, trehalose, gentianose, raffinose and planteose are preferable, since they have an interfacial activity, i.e., they can reduce any surface tension. Sucrose and trehalose is more preferable. Sucrose is particularly preferable, since sucrose has a good commercially availability, a good cost performance, and the like.

The oxyalkylene group having 2 to 4 carbon atoms, i.e., OA moiety includes oxyethylene (eo), oxypropylene (po), oxybutylene (bo), a combination thereof, and the like. Among others, oxypropylene and oxybutylene are preferable, since they can improve any interfacial activity, and particularly they can reduce any surface tension. Oxypropylene is more preferable.

The number of the OA moieties is n and the OA moieties may be the same or different. In the {H—(OA)ₙ-} moiety, the order of the oxyalkylene group (i.e., block structure, random structure and a combination thereof), the number of the oxyalkylene groups and the species of the oxyalkylene group are not limited. The number of the {H—(OA)ₙ-} moieties is m and the {H—(OA)ₙ-} moieties may be the same or different. For example, the {H—(OA)ₙ-} moieties, herein the number of the {H—(OA)ₙ-} moieties is m, includes at least one {H—(OA)ₙ-} moiety wherein n may be 0. Alternatively, the {H—(OA)ₙ-} moieties includes various {H—(OA)ₙ-} moieties wherein the number (n) and the species of the oxyalkylene groups may be independently different.

In the case that the OA moiety of the {H—(OA)ₙ-} moiety includes an oxyethylene group, and an oxypropylene group or/and an oxybutylene group, it is preferable that the oxypropylene group or/and an oxybutylene group present at an end portion far from the residue (Q), i.e., a portion near to the hydrogen atom (H). Alternatively, in the case that the OA moiety of the {H—(OA)ₙ-} moiety includes an oxyethylene group and an oxypropylene group or/and an oxybutylene group, it is preferable that the oxyethylene group is directly attached to the residue (Q).

In the case that the OA moiety of the {H—(OA)ₙ-} moiety includes a plurality species of the oxyalkylene groups, it is preferable that the OA moiety presents as a block structure of the oxyalkylene group. In the case that the OA moiety of the {H—(OA)ₙ-} moiety includes oxyethylene group, content of the oxyethylene group is preferably within a range of from 1 to 20 wt %, more preferably within a range of from 1 to 15 wt %, and particularly preferably within a range of from 1 to 10 wt % relative to the weight of the {H—(OA)ₙ-}ₘ moiety.

The total number (n×m) of the OA moieties in a molecule is preferably within a range of from 47 to 100, more preferably within a range of from 50 to 95, particularly preferably within a range of from 55 to 90, and most preferably within a range of from 60 to 85. When the total number (n×m) is within the above defined-range, it seems that interfacial activity and dispersibility to water can be further improved, and particularly surface tension can be reduced.

The number n is preferably an integer of from 1 to 100, more preferably an integer of from 10 to 80, particularly preferably an integer of from 15 to 60, and most preferably an integer of from 20 to 40, since properties such as interfacial activity and water dispersibility can be improved, and particularly surface tension can be reduced.

The number m is preferably an integer of from 2 to 4, and more preferably an integer of 2 or 3. When the number m is within the above-defined range, it seems that properties such as interfacial activity and water dispersibility can be further improved, and particularly surface tension can be reduced.

Herein, if necessary, the terminal hydroxyl group of the polyoxyalkylene compound (A), i.e., the terminal OH group in the {H—(OA)ₙ-} moiety can be appropriately protected with an appropriate protective group according to a method known to those skilled in the art.

The protective group for the hydroxyl group includes, but is not particularly limited to, for example, the protective group for the conventional hydroxyl group known to those skilled in the art, preferably, such as an alkyl group having 1 to 3 carbon atoms (e.g., a methyl group, an ethyl group, a propyl group and an isopropyl group), an alkenyl group having 3 carbon atoms (e.g., an allyl group and an isoallyl group), etc.

When the compound (A) has a plurality of the hydroxyl groups and the protective groups therefor, the protective groups may be identical or different.

The preferable polyoxyalkylene compound (A) represented by the general formula (1) includes compounds represented by the following formulae (2) to (20), etc. Hereinafter, po moiety represents an oxypropylene group, eo moiety represents an oxyethylene group, bo moiety represents an oxybutylene group, Q¹ moiety represents residue of sucrose, Q² moiety represents residue of raffinose, and Q³ moiety represents residue of melezitose.

{H-(po)₁₉-}₃Q¹ (2)

{H-(po)₂₀-}₃Q¹ (3)

{H-(po)₂₅-}₃Q¹ (4)

{H-(po)₂₈-}₃Q¹ (5)

{H-(po)₃₀-}₃Q¹ (6)

{H-(po)₂₅-(eo)₃-}₃Q¹ (7)

{H-(po)₂₇-(eo)₁-}₃Q¹ (8)

{H-(bo)₂-(po)₂₃-(eo)₂-}₃Q¹ (9)

{H-(po)₁₇-}₂Q¹{-(po)₃₀-H} (10)

{H-(po)₁₀-}₂Q¹{-(po)₆₀-H} (11)

{H-(eo)₂-}Q¹{-(eo)₃-(po)₃₄-H}₂ (12)

{H-(po)₃₈-}₂Q¹H (13)

{H-(po)₂₀-(po₂/eo₂)-}₃Q¹ (14)

{H-(bo)₂-(po)₂₀-(po₂/eo₂)-}₃Q^{1 (}15)

{H-(bo)₃-(po)₂₂-}₃Q² (16)

{H-(bo)₂-(po)₃₇-}₂Q²H (17)

{H-(po)₂₀-}₄Q³ (18)

{H-(po)₁₉-(eo)₂-}₄Q³ (19)

{H-(bo)₂-(po)₂₄-}₃Q³H (20)

The (po₂/eo₂) moiety represents a combination of 2 mol of the po moiety and 2 mol of the eo moiety at random.

Each of the terminal hydroxyl groups of the compounds represented by the above-defined formula (2) to (20) may be appropriately protected with the above-described protective group for the hydroxyl group.

Among others, the compounds represented by the formula (3), (4), (5), (6), (9) and (18) are preferable. The compound represented by the formula (4) is more preferable.

In a case that the residue (Q) is a residue of the nonreducing disaccharide i.e., the nonreducing disaccharide or trisaccharide (i.e., compound (a1)) is a nonreducing disaccharide, clouding point (° C.) of the polyoxyalkylene compound (A) is preferably within a range of from 25 to 40, more preferably within a range of from 28 to 38, and particularly preferably within a range of from 32 to 36. Accordingly, the clouding point (° C.) of the compound (A) is preferably 25 or more, more preferably 28 or more, and particularly preferably 32 or more as well as preferably 40 or less, more preferably 38 or less, and particularly preferably 36 or less.

In a case that the residue (Q) is the residue of the nonreducing trisaccharide, i.e., the nonreducing disaccharide or trisaccharide (i.e., compound (a1)) is a nonreducing trisaccharide, clouding point (° C.) of the polyoxyalkylene compound (A) is preferably within a range of from 25 to 55, more preferably within a range of from 28 to 50, particularly preferably within a range of from 30 to 47, and most preferably within a range of from 33 to 45. Accordingly, herein, clouding point (° C.) of the compound (A) is preferably 25 or more, more preferably 28 or more, particularly preferably 30 or more, and most preferably 33 or more as well as preferably 55 or less, more preferably 50 or less, particularly preferably 47 or less, and most preferably 45 or less.

Herein, the clouding point is a physical value and an index for hydrophilicity and/or hydrophobicity of surfactant. A higher clouding point means a higher hydrophilicity. The clouding point can be determined according ISO 1065-1975 (E): the “Measurement method B” in the “Ethylene oxide nonionic surfactant—Measurement method of clouding point” (wherein a sample is added to an aqueous solution of butyldiglycol having 25 wt % concentration such that concentration of the sample is 10 wt %). Accordingly, a sample is added to a 25 wt % aqueous solution of butyldiglycol (i.e., 3,6-oxadecylalcohol which is an adduct of butanol with 2 mol of EO), such that the sample concentration is 10 wt %, to give a homogeneous sample solution. Generally, the solution can be prepared at 25° C. In a case that the solution can not be prepared, i.e., sample can not be dissolved therein, the mixture is cooled until the mixture turns to a transparent solution. Subsequently, about 5 cc of the sample solution is charged into a test tube (outer diameter: 18 mm, full length: 165 mm, and wall thickness: about 1 mm). The test tube is equipped with a thermometer scaled by 0.5° C. (diameter: about 6 mm, length: about 250 mm) immersed into the sample solution. The solution is allowed to be heated at a rate of 1.0±0.2° C./min with stirring in order to haze the test solution. Subsequently, the sample solution is allowed to be cooled at a rate of 1.0±0.5° C./min with stirring in order to make the sample solution to be transparent. A temperature that the solution is to be transparent is recorded. The temperature is a clouding point.

The polyoxyalkylene compound (A) in an aqueous solution (concentration: 0.1 wt %) has a dynamic surface tension (at 25±0.2° C., mN/m) preferably within a range of from 40 to 50 at 20 Hz, more preferably within a range of from 40 to 48, and particularly preferably within a range of from 40 to 45. The difference between the dynamic surface tension at 20 Hz and the dynamic surface tension 0.05 Hz is preferably 12 mN/m or less, more preferably 10 mN/m or less, and particularly preferably 8 mN/m or less.

Herein, the dynamic surface tension can be measured with an automatic apparatus for measuring a dynamic surface tension (e.g., “Automatic dynamic surface tension meter BP-D3” manufactured by KYOWA Interface Science Co., Ltd., and “KRUSS BP-2” manufactured by KRUSS Co., Ltd.) according to a maximum bubble pressure method under conditions: temperature of the aqueous solution: 25±0.2° C., sample concentration: 0.1 wt % (wherein dilution medium is deionized water), bubble-generating gas: dried air (which has a relative humidity of 40±5%), and measurement period: 500 msec. Herein, blank conditions are determined or confirmed so that the dynamic surface tension of deionized water is to be within a range of from 73.0 to 72.0 mN/m at 20 to 0.05 Hz. Herein, the dynamic surface tension at 20 Hz means a surface tension past 1/20 second (50 msec) after a new interface is formed. The dynamic surface tension at 0.05 Hz means a surface tension past 20 seconds after a new interface is formed.

In a case that a new interface is formed in an aqueous solution containing another component such as a surfactant, the aqueous solution requires some time to allow the surface tension to reach to equilibrium. As a measurement method of the surface tension, a ring method, a plate method and the like are well known to those skilled in the art. These measurement methods, however, relates to measurement of the surface tension reached to equilibrium (i.e., static surface tension). Herein, the dynamic surface tension is a variable surface tension between a gas phase and a liquid phase. The dynamic surface tension can be determined by a method such as a Maximum Bubble Pressure Method, a Differential Maximum Bubble Pressure Method or the like, wherein a surface tension (mN/m), in the case that a new interface or surface is formed, can be determined in a msec (see Journal of Chemical Society, vol. 121, p. 858 in 1922; Journal of Colloid and Interface Science, vol. 166, p. 6 in 1944; and ASTM D3825-90, etc.).

The polyoxyalkylene compound (A) can be obtained/obtainable by a reaction of the nonreducing disaccharide or trisaccharide (compound (a1)) and the alkyleneoxide having 2 to 4 carbon atoms (compound (a2)).

Herein, the polyoxyalkylene compound (A) can be obtained or obtainable by a reaction between the polyoxyalkylene compound obtained or obtainable by the reaction of the nonreducing disaccharide or trisaccharide (compound (a1)) with the alkyleneoxide (compound (a2)), an alkylene dihalide having 2 to 4 carbon atoms (e.g., ethylene dichloride, propylene dichloride, butylene dibromide, and the like), and a polyoxyalkylene glycol (wherein the alkylene having 2 to 4 carbon atoms) (i.e., Williamson synthesis method), wherein a further polyoxyalkylene group can be attached to at least one hydroxyl group of the polyoxyalkylene compound, which includes a terminal hydroxyl group of the polyoxyalkylene group (e.g., the compounds represented by the above-listed formulae (10), (11), (12), (13), (17) and (20)).

Alternatively, the polyoxyalkylene compound (A) can be obtained or obtainable by reacting the nonreducing disaccharide or trisaccharide (compound (a1)), which has been partially esterified and has an acyl group having 2 to 4 carbon atoms such as acetyl, propanoyl and butanoyl groups, with the alkyleneoxide (compound (a2)), and then subjecting to a hydrolysis to deprotect the acyl group to give a polyoxyalkylene compound having a primary hydroxyl group (e.g., the compounds represented by the above-listed formulae (13), (17) and (20)).

The reaction of the nonreducing disaccharide or trisaccharide (compound (a1)) with the alkyleneoxide (compound (a2)) can be carried out in any manner including an anionic polymerization, a cationic polymerization, a coordinate anionic polymerization, etc. Herein, the polymerization can be carried out alone or in a combination thereof depending on desired degree of polymerization of the resulting compound, etc. Herein, in either of the polymerization manners, the alkyleneoxide (compound (a2)) can be selectively reacted with a primary hydroxyl group among the whole hydroxyl groups (including primary hydroxyl groups and secondary hydroxyl groups) of the nonreducing disaccharide or trisaccharide (compound (a1)).

A catalyst can be used for the reaction of the nonreducing disaccharide or trisaccharide (compound (a1)) with the alkyleneoxide (compound (a2)). The catalyst includes a conventional catalyst for an addition of an alkyleneoxide, and the like, such as hydroxides of alkali metals or alkali earth metals (e.g., potassium hydroxide, rubidium hydroxide, cesium hydroxide, magnesium hydroxide, calcium hydroxide, barium hydroxide, and the like); alcoholates of alkali metals (e.g., potassium methylate, cesium ethylate, and the like); carbonates of alkali metal or alkali earth metals (e.g., potassium carbonate, cesium carbonate, barium carbonate, and the like); tertiary amines having 3 to 24 carbon atoms (e.g., trimethylamine, trioctylamine, triethylenediamine, tetramethylethylenediamine, and the like); and Lewis acids (e.g., stannic chloride, boron trifluoride, and the like). Among others, the hydroxides of alkali metals and the tertiary amine compounds are preferable. Potassium hydroxide, cesium hydroxide and trimethylamine are more preferable.

The amount of the catalyst for the reaction to be used (in wt %) is preferably within a range of from 0.05 to 2 wt %, more preferably within a range of from 0.1 to 1 wt %, and particularly preferably within a range of from 0.2 to 0.6 wt %, relative to the total weight of the compounds (a1) and (a2). Accordingly, herein, the amount of the catalyst to be used (in wt %) is preferably 0.05 wt % or more, more preferably 0.1 wt % or more, and particularly preferably 0.2 wt % or more, relative to the weight of the resulting reaction product after the reaction, as well as, preferably 2 wt % or less, more preferably 1 wt % or less, and particularly preferably 0.6 wt % or less. Herein, the catalyst for the reaction is unnecessary to be used, when an amide, which is described below, is used as a solvent for the reaction.

Herein, the catalyst for the reaction is preferably removed from the reaction product. The method for removing the catalyst includes a method of using an alkali adsorbing agent such as a synthetic aluminosilicate (e.g., KYOWARD 700 (under a trade name) manufactured by KYOWA Chemical Industry Co., Ltd.) (see Japanese Unexamined Patent Publication No. 53-123499, and the like); a method including dissolving the reaction catalyst into a solvent (e.g., xylene, toluene or the like) and subjecting to rinsing with water (see Japanese Examined Patent Publication No. 49-14359, and the like); a method of using an ion exchange resin (see Japanese Unexamined Patent Publication No. 51-23211, and the like); and a method including neutralizing an alkaline catalyst with carbon dioxide gas and filtrating off a resulting carbonate salt (see Japanese Examined Patent Publication No. 52-33000, and the like), etc.

The removal of the catalyst used for the reaction can be evaluated, if the removal is completed, by a CPR (Controlled Polymerization Rate) according to JIS K1557-1970. The rate is preferably 20 or less, more preferably 10 or less, particularly preferably 5 or less, and most preferably 2 or less.

The reaction can be carried out in a reaction vessel. The preferable reaction vessel includes a pressure proof reaction vessel which can be heated, cooled and stirred. Preferably, the reaction can be carried out in the reaction vessel in vacuo wherein the alkyleneoxide (compound (a2)) is introduced. Alternatively, the reaction can be carried out under an atmosphere of a dried inert gas (e.g., argon, nitrogen, carbon dioxide, and the like) wherein the alkyleneoxide (compound (a2)) is introduced. Herein, temperature for the reaction (° C.) is preferably within a range of from 80 to 150° C., and more preferably within a range of from 90 to 130° C. The pressure for the reaction (in a gauge pressure: MPa) is preferably 0.8 MPa or less, and more preferably 0.5 MPa or less.

The confirmation of completion of the reaction can be carried out by the following method, etc. Herein, the reaction temperature is kept a constant for 15 minutes. In this period, if the reaction is completed, the reaction pressure (in a gauge pressure: MPa) is dropped to 0.001 MPa or less. Accordingly, it indicates the completion of the reaction. The time for the reaction is generally within a range of from 4 to 12 hours.

A solvent can be used for the reaction of the nonreducing disaccharide or trisaccharide (compound (a1)) with the alkyleneoxide (compound (a2)). The reaction solvent includes, but is not particularly limited to, for example, (1) solvents without any active hydrogen atoms and/or (2) solvents which can dissolve the nonreducing disaccharide or trisaccharide (compound (a1)), the alkyleneoxide (compound (a2)) and the polyoxyalkylene compound (A) at the selected reaction temperature. It is preferable the solvent includes (3) solvents having any catalyst effect without adding the catalyst for the reaction in addition to the solvents (1) and (2). Such reaction solvent includes amides such as alkylamides having 3 to 8 carbon atoms, heterocyclic amides having 5 to 7 carbon atoms, etc.

The alkylamides include N,N-dimethylformamide (DMF), N,N-dimethylacetoamide, N,N-diethylacetoamide, N-methyl-N-propylacetoamide, 2-(dimethylamino)acetoaldehydedimethylacetal, etc. The heterocyclic amides include N-methylpyrrolidone, N-methyl-ε-caprolactam, N,N-dimethylpyrrole carboxylic amide, etc.

Among others, alkylamides and N-methylpyrrolidone are preferable. DMF, N,N-dimethylacetoamide, 2-(dimethylamino)acetoaldehydedimethylacetal and N-methylpyrrolidone are more preferable. DMF and N-methylpyrrolidone are particularly preferable. DMF is the most preferable.

The amount of the solvent to be used for the reaction (in wt %) is preferably within a range of from 50 to 200 wt %, more preferably within a range of from 60 to 180 wt %, and particularly preferably within a range of from 70 to 150 wt %, relative to the total weight of the compounds (a1) and (a2). Accordingly, herein, the amount of the solvent to be used for the reaction (in wt %) is preferably 50 wt % or more, more preferably 60 wt % or more, and particularly preferably 70 wt % or more, relative to the weight of the resulting reaction product, as well as, preferably 200 wt % or less, more preferably 180 wt % or less, and particularly preferably 150 wt % or less.

When the reaction solvent is used, the reaction solvent is preferably removed off after the reaction. The reaction solvent is more preferably removed off by a distillation under a reduced pressure, and if necessary, in the presence of an absorbent. When the distillation under a reduced pressure is carried out, there can be applied a method of distillation at 100 to 150° C. under a reduced pressure within a range of from 5 to 200 mmHg, etc. Herein, when the solvent is removed with an absorbent, a method including a treatment with an alkali absorbent such as a synthetic alumino silicate (e.g., KYOWARD 700 (under a trade name) manufactured by KYOWA Chemical Industry Co., Ltd.) and the like can be applied. The amount of the alkali absorbent to be added is generally within a range of from 0.1 to 10 wt % relative to the weight of the polyoxyalkylene compound (A). The temperature for the treatment is within a range of from 60 to 120° C. The time for the treatment is within a range of from 0.5 to 5 hours. Subsequently, the alkali absorbent can be removed off by a filtration with a filtration paper. The residual amount of the reaction solvent (in wt %) is preferably 0.1 wt % or less, more preferably 0.05 wt % or less, and particularly preferably 0.01 or less, relative to the weight of the polyoxyalkylene compound (A). Herein, the residual amount of the reaction solvent can be determined by a gas chromatography with an internal standard.

According to the present invention, the surfactant comprising a reaction product obtained/obtainable by a reaction of (a1) a nonreducing disaccharide or trisaccharide with (a2) an alkyleneoxide having 2 to 4 carbon atoms can be prepared by the above-described synthesis method, but includes commercially available products.

The commercially available surfactant includes, but is not particularly limited to, for example, SN-001S, SN-005S, SN CLEANACT 82, SN CLEANACT 830 (each of which is a sucrose-polyether surfactant manufactured by SAN NOPCO Ltd.), and the like.

The surfactant to be used in the present invention preferably includes the surfactant essentially comprising a reaction product obtained or obtainable by a reaction of (a1) a nonreducing disaccharide or trisaccharide with (a2) an alkyleneoxide having 2 to 4 carbon atoms, more preferably comprising the polyoxyalkylene compound (A), as an essential component, which may be a combination of the polyoxyalkylene compounds (A). The surfactant may further comprise other component such as another surfactant, another solvent, or the like.

The another surfactant includes a known surfactant such as a nonionic surfactant, a cationic surfactant, an anionic surfactant, an ampholytic surfactant, etc.

The nonionic surfactant preferably includes an alkyleneoxide adduct of alkyl (preferably having 8 to 18 carbon atoms)-phenol (addition number: 2 to 60); an alkyleneoxide adduct of an alkanol (preferably having 8 to 22 carbon atoms) (addition number: 3 to 50); an ester of a polyalcohol and a fatty acid (preferably having 5 to 8 carbon atoms); an alkyleneoxide adduct of an alkylamine (preferably having 4 to 18 carbon atoms) (addition number: 1 to 45); an alkyleneoxide adduct of a fatty acid amide (preferably having 4 to 18 carbon atoms) (addition number: 1 to 45); acetylene glycol (preferably having 14 to 16 carbon atoms); an alkyleneoxide adduct of acetylene glycol (addition number: 1.3 to 30); polyoxyalkylene-modified silicone (dynamic viscosity at 25° C.: 300 to 100000 centistokes) (the number of oxyalkylene: 20 to 80), etc.

The cationic surfactant preferably includes an amine salt, a quaternary ammonium salt, a polyoxyalkylene addition type ammonium salt, etc.

The anionic surfactant preferably includes a salt of a fatty acid (preferably having 8 to 18 carbon atoms), an α-olefin sulfonate (preferably having 12 to 18 carbon atoms), alkyl (preferably having 4 to 36 carbon atoms)—benzene sulfonic acid and salt thereof, an alkyl sulfate (preferably having 4 to 18 carbon atoms), an alkyl ether sulfate (preferably having 4 to 18 carbon atoms), a salt of an N-acylalkyl (preferably having 6 to 18 carbon atoms)—taurine, an alkyl sulfo-succinate (preferably having 10 to 22 carbon atoms), etc.

The ampholytic surfactant preferably includes imidazolinium betaine, amide betaine, betaine acetate, etc.

The another surfactant preferably includes a commercially available surfactant under a trade name, such as SN WET 123 and SN WET 970 (manufactured by SAN NOPCO Ltd.), LIONOL TDL-30, 50 and 70 (manufactured by Lion Corporation), IONET T-80C, S-80 and DO-600 (manufactured by SANYO Chemical Industries Ltd.), SOFTANOL 30, 30S and MES-5 (manufactured by Nippon Shokubai Co., Ltd.), SURFYNOL 104, 440 and ENVIRO GEM AD01 (manufactured by AIR PRODUCTS AND Chemicals INC.), etc.

The content of the another surfactant to be added (in wt %) is preferably within a range of from 1 to 40 wt %, more preferably within a range of from 5 to 30 wt %, and particularly preferably within a range of from 10 to 25 wt %, relative to the weight of the effective amount of the above-described surfactant such as the polyoxyalkylene compound (A). Accordingly, herein, the content of the another surfactant to be added (in wt %) is preferably 1 wt % or more, more preferably 5 wt % or more, and particularly preferably 10 wt % or more, relative to the weight of the effective amount of the surfactant, as well as, preferably 40 wt % or less, more preferably 30 wt % or less, and particularly preferably 25 or less.

The another solvent includes water, various water-soluble organic solvents, etc. The water includes, for example, deionized water, distilled water, etc. The water-soluble organic solvents includes an alcohol having 1 to 4 carbon atoms, a ketone having 3 to 7 carbon atoms, an ether having 4 to 6 carbon atoms, an ether-ester having 6 to 8 carbon atoms, etc. The alcohol includes, for example, methanol, ethanol, isopropanol, etc. The ketone includes, for example, acetone, methyl ethyl ketone, methyl isobutyl ketone, etc. The ether includes, for example, ethyl cellosolve, butyl cellosolve, etc. The ether-ester includes, for example, butyl cellosolve acetate, etc.

The content of the another solvent to be added (in wt %) is preferably within a range of from 1 to 20 wt %, more preferably within a range of from 3 to 17 wt %, and particularly preferably with in a range of from 5 to 15 wt %, relative to the weight of the effective amount of the surfactant. Accordingly, herein, the content of the another solvent to be added (in wt %) is preferably 1 wt % or more, more preferably 3 wt % or more, and particularly preferably 5 wt % or more, relative to the weight of the effective amount of the surfactant, as well as, preferably 20 wt % or less, more preferably 17 wt % or less, and particularly preferably 15 wt % or less.

The content of the surfactant in the waterborne metallic color base coating composition according to the present invention (in wt %) is within a range of from 1 to 20 wt %, preferably within a range of from 2 to 12 wt %, and more preferably within a range of from 4 to 10 wt %, relative to solid content of the waterborne metallic color base coating composition as a basis of weight.

When the content of the surfactant (in wt %) is less than 1 wt %, there may be problems such as decrease in application workability such as popping property, etc. When the content of the surfactant (in wt %) is exceeds 20 wt %, there may be problems such as decrease in viscosity of the coating composition, and decrease in application workability, etc.

The above-described surfactant can stabilize the acryl emulsion and the water dispersion of the hydrophobic melamine resin. Therefore, addition of the above-described surfactant to the metallic color coating composition, particularly to the waterborne metallic color base coating composition can suppress and/or prevent skinning of the metallic color coating composition and aggregate due to agglomeration.

Acryl Emulsion resin

The acryl emulsion resin to be used in the second embodiment includes, for example, the above-described acryl emulsion resin to be used in the first embodiment, which can be obtained or obtainable by an emulsion polymerization of a mixture of α,β-ethylenically unsaturated monomers.

Curing Agent of melamine resin

The melamine resin as a curing agent includes, for example, a butyl-etherified melamine resin, a methyl-etherified melamine resin and a methyl/butyl mix-etherified alkylated melamine resin. Among others, a hydrophobic melamine resin is preferably, since the hydrophobic melamine resin can provide the resulting coating film with excellent physical properties or water resistance. The butyl-etherified melamine resin having butyl ether group, as an alkyl group, is preferable, since such melamine resin can provide an excellent reactivity. The curing agent of the melamine resin is added to the waterborne metallic color base coating composition according to the present invention. It is preferable that the curing agent of the hydrophobic melamine resin in a form of water dispersion, wherein the hydrophobic melamine resin is dispersed in an aqueous medium with a specific dispersing resin, is added to the waterborne metallic color base coating composition according to the present invention, since the water dispersion can provide a stabilized curability of the melamine resin and a storage stability of the resulting coating composition.

According to the present invention, the preferable water dispersion of the hydrophobic melamine resin comprises a water dispersion of a hydrophobic melamine resin having an average particle size within a range of from 20 to 300 nm. The water dispersion is obtained/obtainable by a method including steps of reacting a specific acrylic resin with a hydrophobic melamine resin to provide a reaction product; and dispersing the resulting reaction product into water. The waterborne metallic color base coating composition according to the present invention comprises such water dispersion of the hydrophobic melamine resin. Therefore, the resulting coating has a superior color property. When the average particle size is less than 20 nm, the solid content of the coating composition is remarkably lowered. When the average particle size exceeds 300 nm, the dispersibility into water will be decreased, and therefore, there may be a fear that the adherence property and the surface smoothness of the resulting coating film will be decreased. The average particle size is preferably within a range of from 30 to 250 nm, and more preferably within a range of from 100 to 200 nm. Herein, the above-described average particle size can be determined by a method similar to that described in the average particle size of the above-described acrylic emulsion resin.

The water dispersion of the hydrophobic melamine resin to be used in the second embodiment includes, for example, the above-described water dispersion of the hydrophobic melamine resin to be used in the first embodiment.

Pigment

The pigment to be used in the second embodiment includes the above-described pigments to be used in the first embodiment.

Organic Solvent

The waterborne metallic color base coating composition according to the present invention may further comprise an organic alcohol solvent having a solubility in water within a range of form 0.01 to 5.0 wt % and a boiling point within a range of from 160 to 200° C. and/or an organic glycol-ether solvent having a solubility in water within a range of from 0.01 to 5.0 wt % and a boiling point within a range of from 205 to 240° C. Herein, solubility is a percentage of weight of dissolved organic solvent to 100 parts by weight of water at 20° C.

When the solubility of the organic alcohol solvent into water is less than 0.01 wt %, there may be problems such as remarkable increase in viscosity of the coating composition, etc. When the solubility exceeds 5.0 wt %, there may be problems such as remarkable decrease in viscosity of the coating composition, decrease in application workability, etc. The solubility of the organic alcohol solvent into water is preferably within a range of from 0.05 to 3.0 wt %.

When the boiling point of the organic alcohol solvent is less than 160° C., there may be problems such as decrease in application workability, particularly in popping property, etc. When the boiling point exceeds 200° C., there may be problems such as decrease in application workability, particularly in sagging property, etc. The boiling point of the organic alcohol solvent is preferably within a range of from 170 to 190° C.

The above-described organic alcohol solvent (hereinafter, solubility and boiling point are listed in parentheses) is selected from the group consisting of heptanol (0.5 wt % and 168° C.), 2-ethylhexyl alcohol (0.1 wt % and 184° C.) and cyclohexanol (4.0 wt % and 161° C.). 2-ethylhexyl alcohol is preferable, since 2-ethylhexyl alcohol can stabilize the acryl emulsion resin and the water dispersion of the hydrophobic melamine resin (in their particle sizes).

The content of the organic alcohol solvent in the waterborne metallic color base coating composition is within a range of from 5 to 45 wt % relative to solid resin content of the waterborne metallic color base coating composition as a basis of weight. When the content is less than 5 wt %, the skinning and the aggregate due to agglomeration can not be improved. When the content exceeds 45 wt %, there may be problems such as decrease in application workability, such as sagging property, etc.

When the above-described organic alcohol solvent is added to the waterborne metallic color base coating composition, atomization at coating is improved. Therefore, the skinning and the aggregate due to agglomeration can be significantly prevented.

In addition, the waterborne metallic color base coating composition according to the present invention may further comprise an organic glycol-ether solvent having a solubility in water within a range of from 0.01 to 5.0 wt % and a boiling point within a range of from 205 to 240° C.

When the solubility of the organic glycol-ether solvent into water is less than 0.01 wt %, there may be problems such as remarkable increase in viscosity of the coating composition, etc. When the solubility exceeds 5.0 wt %, there may be problems such as remarkable decrease in viscosity of the coating composition, decrease in application workability, etc. The solubility of the organic glycol-ether solvent into water is preferably within a range of from 0.05 to 3.0 wt %.

When the boiling point of the organic glycol-ether solvent is less than 205° C., there may be problems such as decrease in application workability, particularly in popping property, etc. When the boiling point exceeds 240° C., there may be problems such as decrease in application workability, particularly in sagging property, etc. The boiling point of the organic glycol-ether solvent is preferably within a range of from 210 to 230° C.

The above-described organic glycol-ether solvent (hereinafter, solubility and boiling point are listed in parentheses) is selected from the group consisting of ethylene glycol monohexyl ether (i.e., hexyl glycol, 1.0 wt % and 208° C.), ethylene glycol mono-2-ethylhexyl ether (i.e., 2-ethylhexyl glycol, 0.2 wt % and 225° C.) and dipropylene glycol monobutyl ether (5.0 wt % and 215° C.). Ethylene glycol mono-2-ethylhexyl ether is preferable, since ethylene glycol mono-2-ethylhexyl ether can stabilize the acryl emulsion resin and the water dispersion of the hydrophobic melamine resin (in their particle sizes).

The content of the organic glycol-ether solvent in the waterborne metallic color base coating composition is within a range of from 5 to 45 wt % relative to solid resin content of the waterborne metallic color base coating composition as a basis of weight. When the content is less than 5 wt %, the skinning and the aggregate due to agglomeration can not be improved. When the content exceeds 45 wt %, there may be problems such as decrease in application workability such as sagging property, etc.

The addition of the above-described organic glycol-ether solvent to the waterborne metallic color base coating composition, in addition to the above-described organic alcohol solvent, can give advantages such as provision of excellent stability of the acryl emulsion resin and the water dispersion of the hydrophobic melamine resin (in their particle sizes).

When the waterborne metallic color base coating composition according to the present invention comprises both of the organic alcohol solvent and the organic glycol-ether solvent, weight ratio of the organic alcohol solvent to the organic glycol-ether solvent is within a range of a ratio of from 1/1 to 3/1 (organic alcohol solvent/organic glycol-ether solvent). When the weight ratio is less than 1/1, there may be problems such as decrease in viscosity of the coating composition, etc. For example, in such case, there may also be troubles in application workability. When the weight ratio exceeds 3/1, there may be problems such as temporal decrease in the stability of the acryl emulsion resin and the water dispersion of the hydrophobic melamine resin, etc.

In the waterborne metallic color base coating composition according to the present invention, it is preferable that the organic alcohol solvent and the organic glycol-ether solvent are used in a combination.

In addition to the above-described components, the waterborne metallic color base coating composition according to the present invention may further comprises an additive, which may be usually added to the conventional coating composition, such as a surface conditioner, a dispersing agent, a viscosity conditioner, a thickener, an antioxidant, a ultraviolet inhibitor, a defoaming agent, a pH conditioner, etc.

Method for preparing the waterborne metallic color base coating composition includes, but is not particularly limited to, methods known to those skilled in the art, which can homogeneously disperse the above-described components, for example, methods employing an apparatus such as a kneader or a roll mill, etc.

As described above, the waterborne metallic color base coating composition according to the present invention comprises a surfactant comprising a reaction product obtained/obtainable by a reaction of (a1) a nonreducing disaccharide or trisaccharide and (a2) an alkyleneoxide having 2 to 4 carbon atoms. Therefore, the waterborne coating composition according to the present invention can suppress and/or prevent the skinning and the aggregate due to agglomeration of the metallic color coating composition. The waterborne metallic color base coating composition according to the present invention comprises an organic alcohol solvent having a solubility in water within a range of from 0.01 to 5.0 wt % and a boiling point within a range of from 160 to 200° C. and/or an organic glycol-ether solvent having a solubility in water within a range of from 0.01 to 5.0 wt % and a boiling point within a range of from 205 to 240° C. Therefore, the waterborne coating composition according to the present invention can prevent the skinning and the aggregate due to agglomeration.

Clear Coating Composition

The clear coating composition can be applied in order to form a clear coating film on the metallic color base coating film. The clear coating film can smooth unevenness and glittering due to the metallic color base coating film, etc. The clear coating film can protect the base coating film in order to improve the coating appearance.

The clear coating composition includes, but is not particularly limited to, for example, a coating composition comprising a film forming resin, and if necessary, a curing agent and other additive(s).

The film forming resin includes, but is not particularly limited to, for example, an acryl resin, a polyester resin, an epoxy resin, a urethane resin, etc.

In order to provide excellent properties such as transparency and/or acid etching resistance, the clear coating composition preferably includes, for example, an acryl resin and/or a polyester resin as the film forming resin; and an amino resin and/or a polyisocyanate resin as a curing agent. Alternatively, the clear coating composition preferably includes, for example, an acryl resin and/or a polyester resin in a carboxylic acid-epoxy curing system.

The clear coating composition preferably includes a viscosity-controlling agent, as an additive, in order to prevent sagging of the applied coating composition or miscibility and inversion between coating films, etc. The amount of the viscosity-controlling agent to be added is within a range of from 0.01 to 10 parts by weight, preferably within a range of from 0.02 to 8 parts by weight, and more preferably within a range of from 0.03 to 6 parts by weight, relative to 100 parts by weight of solid resin content of the clear coating composition. When the amount exceeds 10 parts by weight, the appearance of the resulting coating film will be deteriorated. When the amount is less than 0.01 part by weight, viscosity controlling effect is not provided, and therefore it may cause problems such as sagging during formation of the coating film.

The clear coating composition can be provided in a form of an organic solvent type, a waterborne type (including water-soluble, water-dispersible and emulsible types), a nonaqueous dispersion type or a powder type. If necessary, the clear coating composition may further comprise an additive such as a curing catalyst, a surface conditioning agent.

Herein, the above-described clear coating composition in a waterborne type includes, for example, waterborne clear coating composition comprising a film forming resin, which is exemplified in the above-described clear coating composition, and which have been neutralized with a base to be water-soluble. The neutralization can be carried out, before or after the polymerization, by adding a tertiary amine such as dimethylethanolamine, triethylamine, etc.

Method for preparing the clear coating composition includes, but is not particularly limited to, for example, methods known to those skilled in the art. Herein, the clear coating composition includes a commercially available clear coating composition.

Method for Producing Multi Layered Coating Film

The method for producing the multi layered coating film according to the present invention includes the following steps:

a step of applying an intermediate coating composition to an article (e.g., a steel plate which may be chemically treated with a chemical agent such as phosphate, or the like), which may have an undercoat coating such as an electrodeposition coating, in order to form an intermediate coating, wherein the step may be separated in a plurality of stages to carry out plural applications of the coating composition;

a step of applying a waterborne metallic color base coating composition to the intermediate coating in order to form a metallic color base coating, wherein the step may be separated in a plurality of stages to carry out plural applications of the coating composition; and

a step of applying a clear coating composition to the metallic color base coating to form a clear coating, wherein the step may be separated in a plurality of stages to carry out plural applications of the coating composition.

Herein, the multi layered coating film according to the present invention may comprise a further appropriate coating film such as a primer coating film under the multi layered coating film, an overcoat clear coating film upper the multi layered coating film.

Generally, application of the coating composition can be carried out by an electrostatic coating with an air atomized spray. A coating means included, for example, an air spraying type coating machine (e.g., auto REA), a rotational atomized spraying type coating machine (e.g., bell, microbell, micro microbell, cartridge bell), etc.

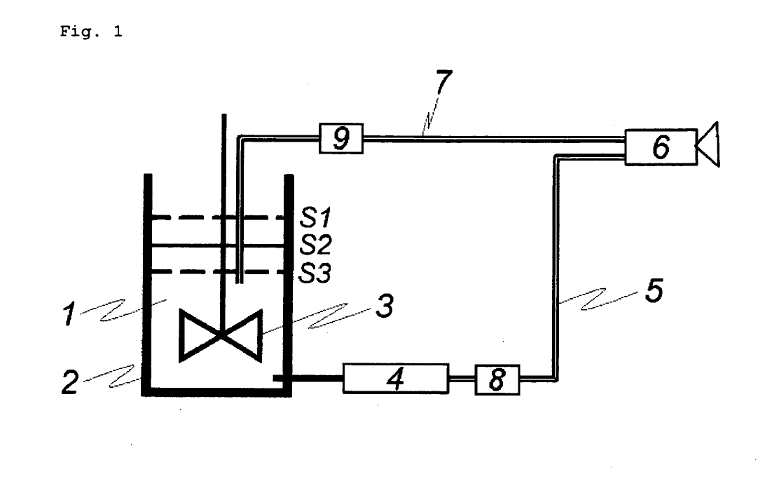

Herein, with respect to the application of the coating composition, the present invention includes a circulation system for the coating composition (see FIG. 1). Specifically, in the circulation system, a coating composition (1) is poured into a circulation tank (2). The coating composition (1) is delivered, with a circulation pump (4) (e.g., Circulation Pump manufactured by GRACO K., K.), to a coating means (6) through a filtration device (8) (e.g., CP FILTER 150 manufactured by Chisso Filter Co., Ltd., etc.) and a tube (5), while the coating composition (1) is mechanically stirred in the circulation tank (2) with a stirring means (3) (e.g., impeller, etc.). After coating, the residue of the coating composition, or unused coating composition is returned to the circulation tank (2) through a tube (7) and a filtration device (9) (e.g., FILTER PAC R-150-NMO-01-ER manufactured by Kajika Corporation, etc). The tubes (5) and (7) are preferably made of stainless steel, since stainless steel has corrosion resistance. While coating, the further coating composition can be poured into the circulation tank (2). The surface (line) or liquid level of the coating composition (1) in the circulation tank (2) can be varied between S1 to S3.

If necessary, the method for producing the multi layered coating film according to the present invention may further include a preheating step after each coating, i.e., application step. The preheating as used herein means that the applied coating composition, i.e., the coating is dried by heating so as not to be cured. The applied coating composition, i.e., coating is generally heated at 40 to 80° C. for 5 to 10 minutes.

Herein, the method for producing the multi layered coating film according to the present invention may further include a baking and drying step (e.g., at 120 to 160° C. for 10 to 40 minutes) to cure the applied coating composition, i.e., the resulting coating, after each coating, i.e., application step.

For example, the cured multi layered coating film includes an electrodeposition coating film, as an undercoat film, having a thickness preferably within a range of from 15 to 25 μm; an intermediate coating film having a thickness preferably within a range of from 10 to 50 μm; a metallic color base coating film having a thickness preferably within a range of from 10 to 35 μm; and a clear coating film having a thickness preferably within a range of from 20 to 80 μm.

The waterborne metallic color base coating composition according to the present invention (as the second embodiment), which can be employed in the method for producing the multi layered coating film of the second embodiment of the present invention, is characterized in that the second embodiment comprises a surfactant comprising the reaction product obtained or obtainable by a reaction of (a1) a nonreducing disaccharide or trisaccharide with (a2) an alkyleneoxide having 2 to 4 carbon atoms, a specific organic alcohol solvent and/or a specific organic glycol-ether solvent, which can significantly suppress and/or prevent skinning of the coating composition and aggregate due to agglomeration.

Hereinafter, the present invention is described in detail with reference to the following Examples. The present invention is not limited to the Examples. The term “part(s)” herein used in the Examples mean(s) “part(s) by weight” unless otherwise noticed.

### EXAMPLES

### Preparation Example 1

### Preparation of acryl Emulsion resin A

126.5 parts of deionized water was charged into a reaction vessel and heated to 80° C. under the nitrogen atmosphere with stirring. Subsequently, a monomer emulsion, as a first mixture of α,β-ethylenically unsaturated monomers, containing 24.42 parts of methyl methacrylate, 25.78 parts of ethyl acrylate, 10.00 parts of styrene, 4.00 parts of acrylamide, 5.80 parts of 2-hydroxyethyl acrylate, 0.5 part of AQUARON HS-10 (which was a polyoxyethylene alkylpropenyl phenyl ether sulfate manufactured by Dai-ichi Kogyou Seiyaku Co., Ltd.), 0.5 part of ADEKA REASOAP NE-20 (which was α-[1-[(allyloxy)methyl]-2-(nonylphenoxy)ethyl]-ω-hydroxyoxyethylene, manufactured by ADEKA Corporation, 80% aqueous solution) and 80 parts of deionized water; and an initiator solution containing 0.24 part of ammonium persulfate and 10 parts of deionized water were simultaneously added dropwise to the reaction vessel over 2 hours. After completion of the dropwise addition, the mixture was allowed to be left at the same temperature for 1 hour.

Subsequently, a monomer emulsion, as a second mixture of α,β-ethylenically unsaturated monomers, containing 24.45 parts of ethyl acrylate, 2.48 parts of 2-hydroxyethyl acrylate, 3.07 parts of methacrylic acid, 0.2 part of AQUARON HS-10 and 10 parts of deionized water; and an initiator solution containing 0.06 part of ammonium persulfate and 10 parts of deionized water were simultaneously added dropwise into the reaction vessel over 0.5 hour at 80° C. After completion of the dropwise addition, the mixture was allowed to be left at the same temperature for 2 hours.

Subsequently, the mixture was cooled to 40° C. and filtrated through a 400 mesh filter. 0.32 part of dimethylaminoethanol was added to the filtrate. The mixture was adjusted to pH 6.5 to give an acryl emulsion resin A having average particle size of 150 nm, non-volatile content of 30%, acid value (of solid content) of 20 mgKOH/g and hydroxyl value (of solid content) of 40 mgKOH/g.

### Preparation Example 2

### Preparation of Water-Soluble acryl resin B (as Film Forming Resin)

23.89 Parts of dipropylene glycol methyl ether and 16.11 parts of propylene glycol methyl ether were charged into a reaction vessel and heated to 105° C. under the nitrogen atmosphere with mixing and stirring. Subsequently, 13.1 parts of methyl methacrylate, 68.4 parts of ethyl acrylate, 11.6 parts of 2-hydroxyethyl methacrylate and 6.9 parts of methacrylic acid; and an initiator solution containing 10.0 parts of dipropylene glycol methyl ether and 1 part of tert-butylperoxy 2-ethylhexanoate were simultaneously added dropwise to the reaction vessel over 3 hours. After completion of the dropwise addition, the mixture was allowed to be left at the same temperature for 0.5 hour.

Subsequently, an initiator solution containing 5.0 parts of dipropylene glycol methyl ether and 0.3 part of tert-butylperoxy 2-ethylhexanoate was added dropwise to the reaction vessel over 0.5 hour. After completion of the dropwise addition, the mixture was allowed to be left at the same temperature for 2 hours.

16.11 parts of the solvent was distilled off at 110° C. under a reduced pressure (at 70 Torr) in a solvent removal device. Subsequently, 204 parts of deionized water and 7.14 parts of dimethylaminoethanol were added thereto to give a water-soluble acryl resin B. The resulting water-soluble acryl resin B has non-volatile content of 30.0%, acid value (of solid content) of 40 mgKOH/g and hydroxyl value (of solid content) of 50 mgKOH/g.

### Preparation Example 3

### Preparation of acryl resin C for melamine Dispersion

50 Parts of MFDG (which was methylpropylene diglycol, manufactured by NIPPON NYUKAZAI CO., LTD.) was added to a reaction vessel and heated to 130° C. under the nitrogen atmosphere with stirring. Subsequently, 16.9 parts of methacrylic acid, 5.4 parts of methyl acrylate, 14.5 parts of 2-hydroxyethyl acrylate and 54.7 parts of ethyl acrylate; and an initiator solution containing 10.0 parts of dipropylene glycol methyl ether and 13 parts of tert-butylperoxy 2-ethylhexanoate were simultaneously added dropwise to the reaction vessel over 3 hours. After completion of the dropwise addition, the mixture was allowed to be left at the same temperature for 0.5 hour.

Subsequently, an initiator solution containing 0.5 part of tert-butylperoxy 2-ethylhexanoate and 5 parts of dipropylene glycol methyl ether was added dropwise thereto over 0.5 hour. After completion of the dropwise addition, the mixture was allowed to be left at the same temperature for 1 hour. Subsequently, the mixture was cooled to 50° C. to give an acryl resin C having non-volatile content of 60%, acid value (of solid content) of 110 mgKOH/g, hydroxyl value (of solid content) of 70 mgKOH/g and number average molecular weight of 3000.

### Preparation Example 4

### Preparation of Water Dispersion of hydrophobic melamine resin (1)

8.1 Parts (5 parts in solid content) of the acryl resin C according to the Preparation Example 3 and 50 parts (30 parts in solid content) of U-VAN 20SB, manufactured by Nihon Cytec Industries Inc., (which was a fully butyl-etherified melamine resin; SP value: 9.7, solid content: 60%) were mixed and the mixture was stirred at 80° C. for 4 hours. Subsequently, 0.8 part of dimethylethanolamine was added thereto. The mixture was adequately stirred to give an uniform mixture and cooled to 40° C. Subsequently, 41 parts of ion-exchanged water was added dropwise to the mixture over 1 hour to give a water dispersion of the hydrophobic melamine resin (1) having average particle size of 150 nm (solid content: 35%).

The SP value of the melamine resin “U-VAN 20SB” was measured by a turbidity titration with a good solvent and a poor solvent as described below (at measurement temperature: 20° C.).

Good solvent: acetone (SP: δg=9.77)

Poor solvent: hexane (SP: δpl=7.24) and
deionized water (SP: δph=23.50)

Preparation of Sample

0.5 g of the melamine resin “U-VAN 20SB” was weighed in a 100 ml beaker. 10 ml of the good solvent (i.e., acetone) was added to the beaker with a whole pipette. The melamine resin was dissolved in the good solvent with stirring by a magnetic stirrer to prepare a measurement resin sample.

Turbidity Titration

Hexane was added dropwise to the above-prepared measurement resin sample with a 50 ml burette. When turbidity was generated, the dropwise added amount of the hexane was recorded. Herein, it was 58.21 ml. The volume proportion of the added hexane (φpl) was 0.8534.

φpl=(58.21)/(58.21+10)≅0.8534

Subsequently, deionized water was added dropwise to the above-prepared measurement resin sample with a 50 ml burette in the same manner as described above to that for the hexane. When turbidity was generated, the dropwise added amount of the deionized water was recorded. Herein, it was 1.74 ml. The volume proportion of the added deionized water (φph) was 0.1482.

φph=(1.74)/(1.74+10)≅0.1482

According to the above-described formulae (1), (2) and (3), the SP value of the melamine resin “U-VAN 20SB” (δpoly) was determined and found it was 9.7.

δml=φpl×δpl+(1−φpl)×δg=(0.8534)×(7.24)+(1−0.8534)×(9.77)≅7.6109

δmh=φph×δph+(1φph)×δg=(0.1482)×(23.50)+(1−0.1482)×(9.77)≅11.8048

δpoly=(δml+δmh)/2=(7.6109+11.8048)/2≅9.7

### Preparation Example 5

### Preparation of Water Dispersion of hydrophobic melamine resin (2)

8.1 Parts (or 5 parts in solid content) of the acryl resin C according to the Preparation Example 3 and 50 parts (or 30 parts in solid content) of U-VAN 20SB (SP value: 9.7), manufactured by Nihon Cytec Industries Inc., (solid content: 60%) were mixed and the mixture was stirred at room temperature (at. 20° C.) for 4 hours. Subsequently, 0.8 part of dimethylethanolamine was added thereto. The mixture was adequately stirred. Subsequently, 41 parts of deionized water was further added dropwise thereto over 1 hour to give a water dispersion of the hydrophobic melamine resin (2) having average particle size of 250 nm (solid content: 35%).

### Preparation Example 6

### Preparation of Water Dispersion of hydrophobic melamine resin (3)

8.1 Parts (or 5 parts in solid content) of the acryl resin C according to the Preparation Example 3 and 0.8 part of dimethylethanolamine were mixed. The mixture was adequately stirred. Subsequently, 41 parts of deionized water was further gradually added thereto with stirring to give a homogeneous aqueous solution of the water-soluble acryl resin C. Subsequently, 50 parts (or 30 parts in solid content) of U-VAN 20SB, manufactured by Nihon Cytec Industries Inc., (SP value: 9.7) (solid content: 60%) was gradually added thereto to give a water dispersion of the hydrophobic melamine resin with the acryl resin C as a protective resin. Subsequently, the mixture was stirred at room temperature for 1 hour to give a water dispersion of the hydrophobic melamine resin (3) having average particle size of 300 nm (solid content: 35%).

### Preparation Example 7

### Preparation of Phosphoric Acid Group-Containing acryl resin (as Dispersing Agent)

40 Parts of ethoxypropanol was charged into an one litter reaction vessel equipped with a stirrer, a temperature controller and a condenser. 121.7 Parts of a monomer solution containing 4 parts of styrene, 35.96 parts of n-butyl acrylate, 18.45 parts of ethylhexyl methacrylate, 13.92 parts of 2-hydroxyethyl methacrylate, 7.67 parts of methacrylic acid, 40 parts of a solution containing 20 parts of PHOSMER PP (which was an acid phosphoxy-hexa(oxypropylene) monomethacrylate manufactured by UNI-CHEMICAL Co., Ltd.) dissolved in 20 parts of ethoxypropanol, and 1.7 parts of azobisisobutyronitrile was added dropwise to the reaction vessel at 120° C. over 3 hours. Subsequently, the mixture was stirred for another 1 hour to give a resin. The resulting resin was an acryl varnish having acid value of 105 mgKOH/g (in which acid value due to phosphoric acid group was 55 mgKOH/g), hydroxyl value of 60 mgKOH/g, number average molecular weight of 6000, and non-volatile content of 63%.

### Example I-1

### Production of Waterborne Metallic Color Base Coating Composition

133.3 Parts of the acryl emulsion resin A according to the Preparation Example 1; 50.0 parts of the water-soluble acryl resin B according to the Preparation Example 2; 101.1 parts of the water dispersion of the hydrophobic melamine resin (1) according to the Preparation Example 4; 16.7 parts of ALPASTE MH-8801 (which was an aluminum luster color pigment and manufactured by Asahi Kasei Corporation, effective ingredient: 75%); 0.5 part of DEGUSSA CARBON FW-200P (which was a carbon black pigment and manufactured by DEGUSSA Japan Co., Ltd.); 5.4 parts of the phosphoric acid group-containing acryl resin according to the Preparation Example 7; 40 parts (or 40 wt % relative to solid resin content) of 2-ethylhexyl alcohol (2EHOH) (manufactured by Mitsubishi Chemical Corporation); 1.0 part of a viscosity conditioner “SN Thickener N-1 (solid content: 25%)” (manufactured by SAN NOPCO Ltd.); 25 parts of crosslinked resin particles (which was a viscosity conditioner, solid content: 30%) (manufactured by Nippon Paint Co., Ltd.); and 10 parts of a 10 wt % aqueous solution of dimethylethanolamine (DMEA) were mixed. The mixture was homogeneously dispersed to give a waterborne metallic color base coating composition.

### Example I-2

### Production of Waterborne Metallic Color Base Coating Composition

A waterborne metallic color base coating composition was prepared in the same manner as described in the Example I-1 with the proviso that the 2EHOH was used in 20 parts (20 wt % relative to solid resin content) and 20 parts (20 wt % relative to solid resin content) of ethylene glycol mono-2-ethylhexyl ether (EHG) (manufactured by NIPPON NYUKAZAI CO., LTD.) was further added (see Table 1).

### Example I-3

### Production of Waterborne Metallic Color Base Coating Composition

A waterborne metallic color base coating composition was prepared in the same manner as described in the Example I-1 with the proviso that, in the absence of the 2EHOH, 40 parts (40 wt % relative to solid resin content) of EHG was added (see Table 1).

### Comparative Examples I-1 to I-3

### Production of Comparative Waterborne Metallic Color Base Coating Compositions

Comparative waterborne metallic color base coating compositions were prepared in the same manner as described in the Example I-1 with the proviso that components listed in the following Table 2 were used (Comparative Examples I-1 to I-3).

Formation of Multi Layered Coating Film (I)

A cationic electrodeposition coating composition “POWERTOP U-50” (manufactured by Nippon Paint Co., Ltd.) was applied to a dull steel panel with a thickness of 0.8 mm, an orthogonal length of 30 cm and a lateral length of 40 cm, which had been treated with zinc phosphate, according to an electrodeposition coating method, so that the dried coated film had a thickness of 20 μm. The panel was heated at 160° C. for 30 minutes. Subsequently, a gray intermediate coating composition “ORGA P-30” (which was a polyester-melamine type coating composition manufactured by Nippon Paint Co., Ltd.), which had been previously diluted (i.e., it took 25 seconds which had been measured at 20° C. with No. 4 Ford cup), was applied to the coated panel with an air spray in 2 stages so that the dried coated film had a thickness of 35 μm. The panel was heated at 140° C. for 30 minutes.

The coated panel was cooled. The waterborne metallic color base coating composition according to the Example I, which had been previously diluted with deionized water (i.e., it took 30 seconds which had been measured at 20° C. with No. 4 Ford cup), was applied in 2 stages with a “μμ BELL type COPES-IV” (manufactured by ABB Industry Co., Ltd.) applicable to a waterborne coating composition under these conditions: room temperature of 25° C. and humidity of 85%, so that the dried coated film had a thickness of 20 μm. An interval for 1 minute was placed between these two application stages. After the second application, a setting was placed for 5 minutes. Subsequently, the panel was subjected to a preheating step at 80° C. for 5 minutes.

After the preheating step, the coated panel was allowed to be left and cooled to room temperature. A clear coating composition “MACFLOW O-1820 CLEAR” (which was a clear coating composition in an acid/epoxy curing system and manufactured by Nippon Paint Co., Ltd.) was applied to the coated panel in one stage, so that the dried coated film had a thickness of 40 μm. A setting was placed for 7 minutes. Subsequently, the coated panel was heated at 140° C. for 30 minutes in a drier to give a coated panel having a multi layered coating film consisting of the electrodeposition coating film, the intermediate coating film, the metallic color base coating film and the clear coating film.

Evaluation of Prevention of Aggregate Due to Agglomeration of Luster Color Pigment

The waterborne metallic color base coating composition was evaluated on prevention of aggregate due to agglomeration of luster color pigment according to the following evaluation method and evaluation basis. The results are shown in the following Tables 1 and 2.

The waterborne metallic color base coating composition of the Example I or the Comparative Example I was horizontally applied to a tin sheet in A3 size with a cartridge bell manufactured by ABB Industry Co., Ltd. The application conditions are described below in detail.

Subsequently, the waterborne metallic color base coating composition was further applied to the coated sheet under dusts generating conditions as described below. After 1 minute, the sheet was preheated in a drying furnace at 80° C.

Baking was carried out at 140° C. for 30 minutes. The aggregate due to agglomeration of luster color pigment was evaluated based on number of generations thereof.

Application Conditions

### First Application

Rotation: 25000 rpm

Applying amount: 200 cc/min

Shaping air (SA) pressure: 600 NL/min

Applied voltage: −90 kV

Distance (from gun to sheet): 30 cm

Moving gun speed: 900 mm/sec

Pass pitch: 65 mm

Two Stage application: Interval=1 minute and 20 seconds

Application booth: Temperature=23° C. and humidity=68%

### Second Application Under Dusts Generating Conditions

Rotation: 10000 rpm

Applying amount: 300 cc/min

Shaping air (SA) pressure: 520 NL/min

Applied voltage: −90 kV

Distance (from gun to sheet): 50 cm

Moving gun speed: 900 mm/sec

Path pitch: 130 mm

Two Stage application: Interval=1 minute and 20 seconds

Application booth: Temperature=23° C. and humidity=68%

Evaluation Basis

The aggregate due to agglomeration of luster color pigment was evaluated based on its generation number as follows.

Excellent (◯): 10 or less

Good (◯Δ): 10 to 30

No good (Δ): 30 to 100

Bad (Δ×): 100 to 200

Terrible (×): 200 or more

TABLE 1

| Waterborne metallic color | | Example | Example | Example |
|---|---|---|---|---|
| base coating composition | | I-1 | I-2 | I-3 |
| Acryl emulsion resin A | | 133.3 | 133.3 | 133.3 |
| (parts by weight) | | | | |
| Water-soluble acryl resin B | | 50.0 | 50.0 | 50.0 |
| (parts by weight) | | | | |
| Water dispersion of | | (1) | (1) | (1) |
| hydrophobic melamine resin | | 101.1 | 101.1 | 101.1 |
| (parts by weight) | | | | |
| Conditions for mixing | | 80° C. | 80° C. | 80° C. |
| melamine resin | | 4 hours | 4 hours | 4 hours |
| | | Hot blend | Hot blend | Hot blend |
| Pigment | ALPASTE | 16.7 | 16.7 | 16.7 |
| (parts by | MH-8801 | | | |
| weight) | DEGUSSA | 0.5 | 0.5 | 0.5 |
| | CARBON | | | |
| | FW-200P | | | |
| Organic | 2EHOH | 40 | 20 | 0 |
| solvent | EHG | 0 | 20 | 40 |
| (parts by | | | | |
| weight)) | | | | |
| Dispersing | Phosphoric | 5.4 | 5.4 | 5.4 |
| agent | acid group- | | | |
| (parts by | containing | | | |
| weight) | acryl resin | | | |
| | of | | | |
| | Preparation | | | |
| | Example 7 | | | |
| Viscosity | SN Thickener | 1.0 | 1.0 | 1.0 |
| conditioner | N-1 | | | |
| (parts by | Crosslinked | 25 | 25 | 25 |
| weight) | resin | | | |
| | particles | | | |
| pH | 10 wt % | 10 | 10 | 10 |
| conditioner | aqueous | | | |
| (parts by | solution of | | | |
| weight) | DMEA | | | |

| | | | |
|---|---|---|---|
| Prevention of aggregate due | ◯ | ◯Δ | ◯Δ |
| to agglomeration of luster | | | |
| color pigment | | | |

TABLE 2

| | | Comparative | Comparative | Comparative |
|---|---|---|---|---|
| Waterborne metallic color | | Example | Example | Example |
| base coating composition | | I-1 | I-2 | I-3 |
| Acryl emulsion resin A | | 133.3 | 133.3 | 133.3 |
| (parts by weight) | | | | |
| Water-soluble acryl resin B | | 50.0 | 50.0 | 50.0 |
| (parts by weight) | | | | |
| Water dispersion of | | (2) | (2) | (3) |
| hydrophobic melamine resin | | 101.1 | 101.1 | 101.1 |
| (parts by weight) | | | | |
| Conditions for mixing | | 20° C. | 20° C. | 20° C. |
| melamine resin | | 4 hours | 4 hours | 4 hours |
| Pigment | ALPASTE | 16.7 | 16.7 | 16.7 |
| (parts by | MH-8801 | | | |
| weight) | DEGUSSA | 0.5 | 0.5 | 0.5 |
| | CARBON | | | |
| | FW-200P | | | |
| Organic | 2EHOH | 40 | 20 | 40 |
| solvent | EHG | 0 | 20 | 0 |
| (parts by | | | | |
| weight) | | | | |
| Dispersing | Phosphoric | 5.4 | 5.4 | 5.4 |
| agent | acid group- | | | |
| (parts by | containing | | | |
| weight) | acryl resin | | | |
| | of | | | |
| | Preparation | | | |
| | Example 7 | | | |
| Viscosity | SN Thickener | 1.0 | 1.0 | 1.0 |
| conditioner | N-1 | | | |
| (parts by | Crosslinked | 25 | 25 | 25 |
| weight) | resin | | | |
| | particles | | | |
| pH | 10 wt % | 10 | 10 | 10 |
| conditioner | aqueous | | | |
| (parts by | solution of | | | |
| weight) | DMEA | | | |

| | | | |
|---|---|---|---|
| Prevention of aggregate | Δ | Δ | X |
| due to agglomeration of | | | |
| luster color pigment | | | |

ALPASTE MH-8801: Aluminum luster color pigment manufactured by Asahi Kasei Corporation (effective ingredient: 75%)

DEGUSSA CARBON FW-200P: Carbon black pigment manufactured by DEGUSSA Japan Co., Ltd.

2EHOH: 2-Ethylhexyl alcohol manufactured by Mitsubishi Chemical Corporation

EHG: Ethylene glycol mono-2-ethylhexyl ether manufactured by NIPPON NYUKAZAI CO., LTD.

SN Thickener N-1: Viscosity conditioner (solid content: 25%) manufactured by SAN NOPCO Ltd.

Crosslinked resin particles: Viscosity conditioner (solid content: 30%) manufactured by Nippon Paint Co., Ltd.

DMEA: 10 wt % aqueous solution of dimethylethanolamine manufactured by NIPPON NYUKAZAI CO., LTD.

### Example II-1

### Production of Waterborne Metallic Color Base Coating Composition

133.3 Parts of the acryl emulsion resin A according to the Preparation Example 1; 50.0 parts of the water-soluble acryl resin B according to the Preparation Example 2; 8.0 parts of sucrose-polyether surfactant “SN CLEANACT 82” (manufactured by SAN NOPCO Ltd.); 101.1 parts of the water dispersion of the hydrophobic melamine resin (1) according to the Preparation Example 4; 16.7 parts of ALPASTE MH-8801 (which was an aluminum luster color pigment and manufactured by Asahi Kasei Corporation, effective ingredient: 75%); 0.5 part of DEGUSSA CARBON FW-200P (which was a carbon black pigment and manufactured by DEGUSSA Japan Co., Ltd.); 5.4 parts of the phosphoric acid group-containing acryl resin according to the Preparation Example 7; 20 parts (or 20 wt % relative to solid resin content) of 2-ethylhexyl alcohol (2EHOH) (manufactured by Mitsubishi Chemical Corporation); 20 parts (20 wt % relative to solid resin content) of ethylene glycol mono-2-ethylhexyl ether (EHG) (manufactured by NIPPON NYUKAZAI CO., LTD.); 1.0 part of a viscosity conditioner “SN Thickener N-1 (solid content: 25%)” (manufactured by SAN NOPCO Ltd.); 25 parts of crosslinked resin particles (which was a viscosity conditioner, solid content: 30%) (manufactured by Nippon Paint Co., Ltd.); and 2 parts of a 10 wt % aqueous solution of dimethylethanolamine (DMEA) were mixed. The mixture was homogeneously dispersed to give a waterborne metallic color base coating composition.

### Example II-2

### Production of Waterborne Metallic Color Base Coating Composition

A waterborne metallic color base coating composition was prepared in the same manner as described in the Example II-1 with the proviso that 40 parts of the 2EHOH was used instead of 20 parts of the 2EHOH and 20 parts of the EHG in the Example II-1 (see Table 3).

### Example II-3

### Production of Waterborne Metallic Color Base Coating Composition

A waterborne metallic color base coating composition was prepared in the same manner as described in the Example II-1 with the proviso that 3.0 parts of the SN CLEANACT 82 (as surfactant) was used (see Table 3).

### Comparative Examples II-1 to II-3

### Production of Comparative Waterborne Metallic Color Base Coating Compositions

Comparative waterborne metallic color base coating compositions were prepared in the same manner as described in the Example II-1 with the proviso that 40 parts of 2EHOH as an organic solvent was used in the absence of the surfactant (SN CLEANACT 82) (in Comparative Example II-1); 40 parts of EHG as an organic solvent was used in the absence of the surfactant (SN CLEANACT 82) (in Comparative Example II-2); and 20 parts of 2EHOH and 20 parts of EHG as organic solvents were used in the absence of the surfactant (SN CLEANACT 82) (in Comparative Example II-3) (see Table 4).

Formation of Multi Layered Coating Film (II)

A cationic electrodeposition coating composition “POWERTOP U-50” (manufactured by Nippon Paint Co., Ltd.) was applied to a dull steel panel with a thickness of 0.8 mm, an orthogonal length of 30 cm and a lateral length of 40 cm, which had been treated with zinc phosphate, according to an electrodeposition coating method, so that the dried coated film had a thickness of 20 μm. The panel was heated at 160° C. for 30 minutes. Subsequently, a gray intermediate coating composition “ORGA P-30” (which was a polyester-melamine type coating composition manufactured by Nippon Paint Co., Ltd.), which had been previously diluted (i.e., it took 25 seconds which had been measured at 20° C. with No. 4 Ford cup), was applied to the coated panel with an air spray in 2 stages so that the dried coated film had a thickness of 35 μm. The plate was heated at 140° C. for 30 minutes.

The coated panel was cooled. The waterborne metallic color base coating composition according to the Example II, which had been previously diluted with deionized water (i.e., it took 30 seconds which had been measured at 20° C. with No. 4 Ford cup), was applied in 2 stages with a “μμ BELL type COPES-IV” (manufactured by ABB Industry Co., Ltd.) applicable to a waterborne coating composition under these conditions: room temperature of 25° C. and humidity of 85%, so that the dried coated film had a thickness of 20 μm. An interval for 1 minute was placed between these two application stages. After the second application, a setting was placed for 5 minutes. Subsequently, the plate was subjected to a preheating step at 80° C. for 5 minutes.

After the preheating step, the coated panel was allowed to be left and cooled to room temperature. A clear coating composition “MACFLOW O-1820 CLEAR” (which was a clear coating composition in an acid/epoxy curing system and manufactured by Nippon Paint Co., Ltd.) was applied to the coated panel in one stage, so that the dried coated film had a thickness of 40 μm. A setting was placed for 7 minutes. Subsequently, the coated panel was heated at 140° C. for 30 minutes in a drier to give a coated panel having a multi layered coating film consisting of the electrodeposition coating film, the intermediate coating film, the metallic color base coating film and the clear coating film.

Prevention of Skinning

The waterborne metallic color base coating compositions of the Example II and the Comparative Example II were evaluated on prevention of skinning according to the following evaluation procedures and evaluation basis. The results are shown in the following Tables 3 and 4.

Evaluation Procedures

1. The coating composition (in 150 cc) of the Example II or the Comparative Example II was sampled in a 200 ml P.P cup (a cup made of polypropylene, manufactured by MISEC CORPORATION). The coating composition was immediately removed off from the P.P cup.

2. The P.P cup having adhesion of the coating composition was allowed to be left in an incubator (at 20° C.) for 18 hours. Alternately, the P.P cup having adhesion of the coating composition was allowed to be left in an incubator at 40° C. for 30 minutes.

3. The coating composition (in 150 cc) was further added to the P.P cup.

4. The coating composition was stirred in the P.P cup for 3 minutes at 1500 rpm.

5. The coating composition was filtered through a nylon 200 mesh filter (manufactured by Taiyo Wire Cloth Co., Ltd.). Subsequently, the P.P cup was rinsed with water. The rinsing water was also filtered though the mesh filter. The resulting residue on the filter was visually observed.

Evaluation Basis

Excellent (◯): No residue on filter

Good (◯Δ): Slight residue on filter

No good (Δ): Small residue on filter

Bad (Δ×): Much residue on filter

Terrible (×): Bulky residue on filter

Prevention of Aggregate Due to Agglomeration

The waterborne metallic color base coating compositions of the Example II and the Comparative Example II were evaluated on prevention of aggregate due to agglomeration according to the following evaluation procedures and evaluation basis. The results are shown in the following Tables 3 and 4.

Evaluation Procedures

1. The coating composition (in 100 cc) was added to a 200 ml P.P cup (a cup made of polypropylene, manufactured by MISEC CORPORATION) equipped with a stirring bar. Subsequently, the coating composition was stirred on a stirrer at ambient temperature (at about 20° C.) for 3 days.

2. The coating composition was filtered through a 200 mesh filter. The P.P cup was rinsed with water. The rinsing water was also filtered through the mesh filter.

3. The residue of the coating composition and the coating composition adhered on the P.P cup and/or on the stirring bar was visually observed.

Evaluation Basis

Excellent (◯): No residue on filter and No adherence on stirring bar

Good (◯Δ): Slight residue on filter and slight adherence on stirring bar

No good (Δ): Small residue on filter and slight adherence on stirring bar

Bad (Δ×): Much residue on filter and some adherence on stirring bar

Terrible (×): Bulky residue on filter and much adherence on stirring bar

TABLE 3

| Waterborne metallic | | | | |
|---|---|---|---|---|
| color base coating | | Example | Example | Example |
| composition | | II-1 | II-2 | II-3 |
| Acryl emulsion resin A | | 133.3 | 133.3 | 133.3 |
| (parts by weight) | | | | |
| Water-soluble acryl | | 50.0 | 50.0 | 50.0 |
| resin B | | | | |
| (parts by weight) | | | | |
| Curing agent of melamine | | 101.1 | 101.1 | 101.1 |
| resin: U-VAN 20SB | | | | |
| (Dispersion of | | | | |
| Preparation Example 4) | | | | |
| (parts by weight) | | | | |
| Pigment | ALPASTE | 16.7 | 16.7 | 16.7 |
| (parts by | MH-8801 | | | |
| weight) | DEGUSSA | 0.5 | 0.5 | 0.5 |
| | CARBON | | | |
| | FW-200P | | | |
| Surfactant | SN CLEAN | 8.0 | 8.0 | 3.0 |
| (parts by | ACT 82 | | | |
| weight) | | | | |
| Organic | 2EHOH | 20 | 40 | 20 |
| solvent | EHG | 20 | 0 | 20 |
| (parts by | | | | |
| weight) | | | | |
| Dispersing | Phosphoric | 5.4 | 5.4 | 5.4 |
| agent | acid group- | | | |
| (parts by | containing | | | |
| weight) | acryl resin | | | |
| | of | | | |
| | Preparation | | | |
| | Example 7 | | | |
| Viscosity | SN | 1.0 | 1.0 | 1.0 |
| conditioner | Thickener | | | |
| (parts by | N-1 | | | |
| weight) | Crosslinked | 25 | 25 | 25 |
| | resin | | | |
| | particles | | | |
| pH | 10 wt % | 2 | 2 | 2 |
| conditioner | aqueous | | | |
| (parts by | solution of | | | |
| weight) | DMEA | | | |

| | | | |
|---|---|---|---|
| Prevention of skinning | ◯ | ◯Δ | ◯Δ |
| Prevention of aggregate | ◯ | ◯Δ | ◯Δ |
| due to agglomeration | | | |

TABLE 4

| Waterborne metallic | | Comparative | Comparative | Comparative |
|---|---|---|---|---|
| color base coating | | Example | Example | Example |
| composition | | II-1 | II-2 | II-3 |
| Acryl emulsion resin A | | 133.3 | 133.3 | 133.3 |
| (parts by weight) | | | | |
| Water-soluble acryl | | 50.0 | 50.0 | 50.0 |
| resin B | | | | |
| (parts by weight) | | | | |
| Curing agent of melamine | | 101.1 | 101.1 | 101.1 |
| resin: U-VAN 20SB | | | | |
| (Dispersion of | | | | |
| Preparation Example 4) | | | | |
| (parts by weight) | | | | |
| Pigment | ALPASTE | 16.7 | 16.7 | 16.7 |
| (parts by | MH-8801 | | | |
| weight) | DEGUSSA | 0.5 | 0.5 | 0.5 |
| | CARBON | | | |
| | FW-200P | | | |
| Surfactant | SN CLEAN | 0 | 0 | 0 |
| (parts by | ACT 82 | | | |
| weight) | | | | |
| Organic | 2EHOH | 40 | 0 | 20 |
| solvent | EHG | 0 | 40 | 20 |
| (parts by | | | | |
| weight) | | | | |
| Dispersing | Phosphoric | 5.4 | 5.4 | 5.4 |
| agent | acid group- | | | |
| (parts by | containing | | | |
| weight) | acryl resin | | | |
| | of | | | |
| | Preparation | | | |
| | Example 7 | | | |
| Viscosity | SN Thickener | 1.0 | 1.0 | 1.0 |
| conditioner | N-1 | | | |
| (parts by | Crosslinked | 25 | 25 | 25 |
| weight) | resin | | | |
| | particles | | | |
| pH | 10 wt % | 2 | 2 | 2 |
| conditioner | aqueous | | | |
| (parts by | solution of | | | |
| weight) | DMEA | | | |

| | | | |
|---|---|---|---|
| Prevention of skinning | X | Δ | ΔX |
| Prevention of aggregate | X | Δ | ΔX |
| due to agglomeration | | | |

U-VAN 20SB: Fully butyl-etherified melamine resin manufactured by Nihon Cytec Industries Inc. (solid content: 60%, SP=9.7)

ALPASTE MH-8801: Aluminum luster color pigment manufactured by Asahi Kasei Corporation (effective ingredient: 75%)

DEGUSSA CARBON FW-200P: Carbon black pigment manufactured by DEGUSSA Japan Co., Ltd.

SN CLEANACT 82: Sucrose-polyether surfactant manufactured by SAN NOPCO Ltd.

2EHOH: 2-Ethylhexyl alcohol manufactured by Mitsubishi Chemical Corporation

EHG: Ethylene glycol mono-2-ethylhexyl ether manufactured by NIPPON NYUKAZAI CO., LTD.

SN Thickener N-1: Viscosity conditioner (solid content: 25%) manufactured by SAN NOPCO Ltd.

Crosslinked resin particles: Viscosity conditioner (solid content: 30%) manufactured by Nippon Paint Co., Ltd.

DMEA: 10 wt % aqueous solution of dimethylethanolamine manufactured by NIPPON NYUKAZAI CO., LTD.

### INDUSTRIAL APPLICABILITY

Accordingly, the present invention can suppress and/or prevent generation of aggregate due to agglomeration of luster color pigment. Therefore, the present invention, for example, is useful for coatings of vehicle bodies, particularly for coatings of highly expensive cars, etc.

In addition, according to the second embodiment of the present invention, the present invention can provide a waterborne metallic color base coating composition comprising a surfactant comprising a reaction product obtained or obtainable by a reaction of a nonreducing disaccharide or trisaccharide with an alkyleneoxide having 2 to 4 carbon atoms. Therefore, the present invention can suppress and/or prevent skinning of the coating composition and aggregate due to agglomeration, since the present waterborne metallic color base coating composition comprises the above-described surfactant. Therefore, the present invention can provide a multi layered coating film superior in its appearance.

Furthermore, according to the first or the second embodiment, the present invention can provide a method for producing a multi layered coating film, which includes forming an intermediate coating film; a metallic color base coating film resulting from the waterborne metallic color base coating composition according to the present invention; and a clear coating film, in this order, on an article to be coated. In addition, during the formation of the multi layered coating film, the skinning of the coating composition to be used and the aggregate due to agglomeration can be suppressed and/or prevented. Therefore, the resulting multi layered coating film has its excellent appearance.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those skilled in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for producing a multi layered coating film, which comprises steps of:
applying an intermediate coating composition on an article to form an intermediate coating thereon;
applying a metallic color base coating composition on the intermediate coating to form a metallic color base coating thereon; and
applying a clear coating composition on the metallic color base coating to form a clear coating thereon;
wherein
the metallic color base coating composition is waterborne and comprises
an acryl emulsion resin;
a water dispersion of a hydrophobic melamine resin having an average particle size within a range of from 20 to 300 nm;
a luster color pigment; and
an organic alcohol solvent having a solubility in water within a range of from 0.01 to 5.0 wt % and a boiling point within a range of from 160 to 200° C., which is comprised within a range of from 5 to 45 wt % relative to solid resin content of the coating composition as a basis of weight; and
wherein
the water dispersion of a hydrophobic melamine resin is obtained/obtainable by a method comprising steps of:
mixing an acryl resin and a hydrophobic melamine resin in a weight ratio of the acryl resin to the hydrophobic melamine resin within a range of a ratio of from 5/95 to 25/75 [acryl resin/hydrophobic melamine resin (as a basis of solid content)], wherein the acryl resin has an acid value within a range of from 105 to 200 mgKOH/g, a hydroxyl value within a range of from 50 to 200 mgKOH/g and a number average molecular weight within a range of from 1000 to 5000; and
reacting the acryl resin and the hydrophobic melamine resin at a temperature within a range of from 70 to 100° C. for 1 to 10 hours.

2. The method according to claim 1, wherein the acryl emulsion resin is obtained/obtainable by an emulsion polymerization of a mixture of α,β-ethylenically unsaturated monomers, wherein the mixture comprises no less than 65 wt % of a (meth)acrylate having an ester moiety having 1 or 2 carbon atoms and the mixture has an acid value of within a range of from 3 to 50 mgKOH/g.

3. The method according to claim 1, wherein the waterborne metallic color base coating composition further comprises an organic glycol-ether solvent having a solubility in water within a range of from 0.01 to 5.0 wt % and a boiling point within a range of from 205 to 240° C., which is comprised within a range of from 5 to 45 wt % relative to solid resin content of the coating composition as a basis of weight.

4. The method according to claim 3, wherein a weight ratio of the organic alcohol solvent to the organic glycol-ether solvent is within a range of a ratio of from 1/1 to 3/1 [organic alcohol solvent/organic glycol-ether solvent].

5. The waterborne metallic color base coating composition to be used in the method for producing the multi layered coating film according to claim 1.

6. A method for producing a multi layered coating film, which comprises steps of:
applying an intermediate coating composition on an article to form an intermediate coating thereon;
applying a metallic color base coating composition on the intermediate coating to form a metallic color base coating thereon; and
applying a clear coating composition on the metallic color base coating to form a clear coating thereon;
wherein
the metallic color base coating composition is waterborne and comprises
an acryl emulsion resin;
a curing agent of a melamine resin;
a luster color pigment;
a surfactant comprising a reaction product obtained/obtainable by a reaction of (a1) a nonreducing disaccharide or trisaccharide and (a2) an alkyleneoxide having 2 to 4 carbon atoms; and
an organic alcohol solvent having a solubility in water within a range of from 0.01 to 5.0 wt % and a boiling point within a range of from 160 to 200° C., and/or an organic glycol-ether solvent having a solubility in water within a range of from 0.01 to 5.0 wt % and a boiling point within a range of from 205 to 240° C., each of which is comprised within a range of from 5 to 45 wt % relative to solid resin content of the coating composition as a basis of weight.

7. The method according to claim 6, wherein the acryl emulsion resin is obtained/obtainable by an emulsion polymerization of a mixture of α,β-ethylenically unsaturated monomers, wherein the mixture comprises no less than 65 wt % of a (meth)acrylate having an ester moiety having 1 or 2 carbon atoms and the mixture has an acid value of within a range of from 3 to 50 mgKOH/g.

8. The method according to claim 6, wherein the surfactant is obtained/obtainable by a reaction of 1 mol of the nonreducing disaccharide or trisaccharide (a1) and 47 to 100 mol of the alkyleneoxide having 2 to 4 carbon atoms (a2).

9. The method according to claim 6, wherein a weight ratio of the organic alcohol solvent to the organic glycol-ether solvent is within a range of a ratio of from 1/1 to 3/1 [organic alcohol solvent/organic glycol-ether solvent].

10. The waterborne metallic color base coating composition to be used in the method for producing the multi layered coating film according to claim 6.

11. The method according to claim 2, wherein the waterborne metallic color base coating composition further comprises an organic glycol-ether solvent having a solubility in water within a range of from 0.01 to 5.0 wt % and a boiling point within a range of from 205 to 240° C., which is comprised within a range of from 5 to 45 wt % relative to solid resin content of the coating composition as a basis of weight.

12. The waterborne metallic color base coating composition to be used in the method for producing the multi layered coating film according to claim 2.

13. The waterborne metallic color base coating composition to be used in the method for producing the multi layered coating film according to claim 3.

14. The waterborne metallic color base coating composition to be used in the method for producing the multi layered coating film according to claim 4.

15. The method according to claim 7, wherein the surfactant is obtained/obtainable by a reaction of 1 mol of the nonreducing disaccharide or trisaccharide (a1) and 47 to 100 mol of the alkyleneoxide having 2 to 4 carbon atoms (a2).

16. The method according to claim 7, wherein a weight ratio of the organic alcohol solvent to the organic glycol-ether solvent is within a range of a ratio of from 1/1 to 3/1 [organic alcohol solvent/organic glycol-ether solvent].

17. The method according to claim 8, wherein a weight ratio of the organic alcohol solvent to the organic glycol-ether solvent is within a range of a ratio of from 1/1 to 3/1 [organic alcohol solvent/organic glycol-ether solvent].

18. The waterborne metallic color base coating composition to be used in the method for producing the multi layered coating film according to claim 7.

19. The waterborne metallic color base coating composition to be used in the method for producing the multi layered coating film according to claim 8.

20. The waterborne metallic color base coating composition to be used in the method for producing the multi layered coating film according to claim 9.
